(19) United States
(12) Patent Application Publication
(10) Pub. No.: US 2022/0164852 A1
(43) Pub. Date: May 26, 2022

(54) Digital Imaging and Learning Systems and Methods for Analyzing Pixel Data of an Image of a Hair Region of a User's Head to Generate One or More User-Specific Recommendations

(71) Applicant: The Procter & Gamble Company, Cincinnati, OH (US)

(72) Inventors: Supriya Punyani, Singapore (SG); Vandana Reddy Padala, Singapore (SG); Ping Hu, Mason, OH (US)

(21) Appl. No.: 16/953,385

(22) Filed: Nov. 20, 2020

(51) Int. Cl. G06Q 30/06; G06T 7/73; G06N 3/02; A45D 44/00

(52) U.S. Cl. CPC G06Q 30/0631; G06Q 30/0621; G06Q 30/0643; G06T 7/73; A45D 2044/007; A45D 44/005; G06T 2207/20132; G06T 2207/20081; G06T 2207/30196; G06N 3/02

(57) ABSTRACT

Digital imaging and learning systems and methods are described for analyzing pixel data of an image of a hair region of a user's head to generate one or more user-specific recommendations. A digital image of a user is received at an imaging application (app) and comprises pixel data of at least a portion of a hair region of the user's head. A hair based learning model, trained with pixel data of a plurality of training images depicting hair regions of heads of respective individuals, analyzes the image to determine an image classification of the user's hair region. The imaging app generates, based on the image classification, a user-specific recommendation designed to address at least one feature identifiable within the pixel data comprising the at least the portion of a hair region of the user's head. The imaging app renders on displays screen the user-specific recommendation.

### FIELD

The present disclosure generally relates to digital imaging and learning systems and methods, and more particularly to, digital imaging and learning systems and methods for analyzing pixel data of an image of a hair region of a user's head to generate one or more user-specific recommendations.

### BACKGROUND

Generally, multiple endogenous factors of human hair, such as sebum and sweat, have a real-world impact on the visual quality and/or appearance of a user's hair, which may include unsatisfactory hair texture, condition, look and/or hair quality (e.g., frizz, alignment, shine, oiliness, and/or other hair attributes). Additional exogenous factors, such as wind, humidity, and/or usage of various hair-related products, may also affect the appearance of the user's hair. Moreover, user perception of hair related issues typically does not reflect such underlying endogenous and/or exogenous factors.

Thus a problem arises given the number of endogenous and/or exogenous factors in conjunction with the complexity of hair and hair types, especially when considered across different users, each of whom may be associated with different demographics, races, and ethnicities. This creates a problem in the diagnosis and treatment of various human hair conditions and characteristics. For example, prior art methods, including personal consumer product trials can be time consuming or error prone (and possibly negative). In addition, a user may attempt to empirically experiment with various products or techniques, but without achieving satisfactory results and/or causing possible negative side effects, impacting the health or otherwise visual appearance of his or her hair.

For the foregoing reasons, there is a need for digital imaging and learning systems and methods for analyzing pixel data of an image of a hair region of a user's head to generate one or more user-specific recommendations.

### SUMMARY

Generally, as described herein, digital imaging and learning systems are described for analyzing pixel data of an image of a hair region of a user's head to generate one or more user-specific recommendations. Such digital imaging and learning systems provide a digital imaging, and artificial intelligence (AI), based solution for overcoming problems that arise from the difficulties in identifying and treating various endogenous and/or exogenous factors or attributes of human hair.

The digital imaging and learning systems as described herein allow a user to submit a specific user image to imaging server(s) (e.g., including its one or more processors), or otherwise a computing device (e.g., such as locally on the user's mobile device), where the imaging server(s) or user computing device, implements or executes an artificial intelligence based hair based learning model trained with pixel data of potentially 10,000s (or more) images depicting hair regions of heads of respective individuals. The hair based learning model may generate, based on an image classification of the user's hair region, at least one user-specific recommendation designed to address at least one feature identifiable within the pixel data comprising the at least the portion of a hair region of the user's head. For example, at least one portion of a hair region of the user's head can comprise pixels or pixel data indicative of frizz, alignment, shine, oiliness, and/or other attributes of a specific user's hair. In some embodiments, the user-specific recommendation (and/or product specific recommendation) may be transmitted via a computer network to a user computing device of the user for rendering on a display screen. In other embodiments, no transmission to the imaging server of the user's specific image occurs, where the user-specific recommendation (and/or product specific recommendation) may instead be generated by the hair based learning model, executing and/or implemented locally on the user's mobile device and rendered, by a processor of the mobile device, on a display screen of the mobile device. In various embodiments, such rendering may include graphical representations, overlays, annotations, and the like for addressing the feature in the pixel data.

More specifically, as described herein, a digital imaging and learning system is disclosed. The digital imaging and learning system is configured to analyze pixel data of an image of a hair region of a user's head to generate one or more user-specific recommendations. The digital imaging and learning system may include one or more processors and an imaging application (app) comprising computing instructions configured to execute on the one or more processors. The digital imaging and learning system may further comprise a hair based learning model, accessible by the imaging app, and trained with pixel data of a plurality of training images depicting hair regions of heads of respective individuals. The hair based learning model may be configured to output one or more image classifications corresponding to one or more features of hair of the respective individuals. Still further, in various embodiments, computing instructions of the imaging app, when executed by the one or more processors, may cause the one or more processors to receive an image of a user. The image may comprise a digital image as captured by a digital camera. The image may comprise pixel data of at least a portion of a hair region of the user's head. The computing instructions of the imaging app, when executed by the one or more processors, may further cause the one or more processors to analyze, by the hair based learning model, the image as captured by the digital camera to determine an image classification of the user's hair region. The image classification may be selected from the one or more image classifications of the hair based learning model. The computing instructions of the imaging app, when executed by the one or more processors, may further cause the one or more processors to generate, based on the image classification of the user's hair region, at least one user-specific recommendation designed to address at least one feature identifiable within the pixel data comprising the at least the portion of a hair region of the user's head. In addition, the computing instructions of the imaging app, when executed by the one or more processors, may further cause the one or more processors to render, on a display screen of a computing device, the at least one user-specific recommendation.

In addition, as described herein, a digital imaging and learning method is disclosed for analyzing pixel data of an image of a hair region of a user's head to generate one or more user-specific recommendations. The digital imaging and learning method comprises receiving, at an imaging application (app) executing on one or more processors, an image of a user. The image may be a digital image as captured by a digital camera. In addition, the image may comprise pixel data of at least a portion of a hair region of the user's head. The digital imaging and learning method further may further comprise analyzing, by a hair based learning model accessible by the imaging app, the image as captured by the digital camera to determine an image classification of the user's hair region. The image classification may be selected from one or more image classifications of the hair based learning model. In addition, the hair based learning model may be trained with pixel data of a plurality of training images depicting hair regions of heads of respective individuals. Still further, the hair based learning model may be operable to output the one or more image classifications corresponding to one or more features of hair of the respective individuals. The digital imaging and learning method further comprises generating, by the imaging app based on the image classification of the user's hair region, at least one user-specific recommendation designed to address at least one feature identifiable within the pixel data comprising the at least the portion of a hair region of the user's head. The digital imaging and learning method may further comprise rendering, by the imaging app on a display screen of a computing device, the at least one user-specific recommendation.

Further, as described herein, a tangible, non-transitory computer-readable medium storing instructions for analyzing pixel data of an image of a hair region of a user's head to generate one or more user-specific recommendations is disclosed. The instructions, when executed by one or more processors, may cause the one or more processors to receive, at an imaging application (app), an image of a user. The image may comprise a digital image as captured by a digital camera. The image may comprise pixel data of at least a portion of a hair region of the user's head. The instructions, when executed by one or more processors, may further cause the one or more processors to analyze, by a hair based learning model accessible by the imaging app, the image as captured by the digital camera to determine an image classification of the user's hair region. The image classification may be selected from one or more image classifications of the hair based learning model. The hair based learning model may be trained with pixel data of a plurality of training images depicting hair regions of heads of respective individuals. In addition, the hair based learning model may be operable to output one or more image classifications corresponding to one or more features of hair of the respective individuals. The instructions, when executed by one or more processors, may further cause the one or more processors to generate, by the imaging app based on the image classification of the user's hair region, at least one user-specific recommendation designed to address at least one feature identifiable within the pixel data comprising the at least the portion of a hair region of the user's head. The instructions, when executed by one or more processors, may further cause the one or more processors to render, by the imaging app on a display screen of a computing device, the at least one user-specific recommendation.

In accordance with the above, and with the disclosure herein, the present disclosure includes improvements in computer functionality or in improvements to other technologies at least because the disclosure describes that, e.g., an imaging server, or otherwise computing device (e.g., a user computer device), is improved where the intelligence or predictive ability of the imaging server or computing device is enhanced by a trained (e.g., machine learning trained) hair based learning model. The hair based learning model, executing on the imaging server or computing device, is able to more accurately identify, based on pixel data of other individuals, one or more of a user-specific hair feature, an image classification of the user's hair region, and/or a user-specific recommendation designed to address at least one feature identifiable within the pixel data comprising the at least the portion of a hair region of the user's head. That is, the present disclosure describes improvements in the functioning of the computer itself or “any other technology or technical field” because an imaging server or user computing device is enhanced with a plurality of training images (e.g., 10,000s of training images and related pixel data as feature data) to accurately predict, detect, or determine pixel data of a user-specific images, such as newly provided customer images. This improves over the prior art at least because existing systems lack such predictive or classification functionality and are simply not capable of accurately analyzing user-specific images to output a predictive result to address at least one feature identifiable within the pixel data comprising the at least the portion of a hair region of the user's head.

For similar reasons, the present disclosure relates to improvement to other technologies or technical fields at least because the present disclosure describes or introduces improvements to computing devices in the hair care products, whereby the trained hair based learning model executing on the imaging device(s) or computing devices improve the field of hair care, and chemical formulations and recommendations thereof, with digital and/or artificial intelligence based analysis of user or individual images to output a predictive result to address user-specific pixel data of at least one feature identifiable within the pixel data comprising the at least the portion of a hair region of the user's head.

In addition, the present disclosure relates to improvement to other technologies or technical fields at least because the present disclosure describes or introduces improvements to computing devices in the hair care products, whereby the trained hair based learning model executing on the imaging device(s) or computing devices improve the underlying computer device (e.g., imaging server(s) and/or user computing device), where such computer devices are made more efficient by the configuration, adjustment, or adaptation of a given machine-learning network architecture. For example, in some embodiments, fewer machine resources (e.g., processing cycles or memory storage) may be used by decreasing computational resources by decreasing machine-learning network architecture needed to analyze images, including by reducing depth, width, image size, or other machine-learning based dimensionality requirements. Such reduction frees up the computational resources of an underlying computing system, thereby making it more efficient.

Still further, the present disclosure relates to improvement to other technologies or technical fields at least because the present disclosure describes or introduces improvements to computing devices in the field of security, where image of users are preprocessed (e.g., cropped or otherwise modified) to define extracted or depicted hair regions of a user without depicting personal identifiable information (PII) of the user. For example, simple cropped or redacted portions of an image of a user may be used by the hair based learning model described herein, which eliminates the need of transmission of private photographs of users across a computer network (where such images may be susceptible of interception by third parties). Such features provides a security improvement, i.e., where the removal of PII (e.g., facial features) provides an improvement over prior systems because cropped or redacted images, especially ones that may be transmitted over a network (e.g., the Internet), are more secure without including PII information of a user. Accordingly, the systems and methods described herein operate without the need for such non-essential information, which provides an improvement, e.g., a security improvement, over prior system. In addition, the use of cropped images, at least in some embodiments, allows the underlying system to store and/or process smaller data size images, which results in a performance increase to the underlying system as a whole because the smaller data size images require less storage memory and/or processing resources to store, process, and/or otherwise manipulate by the underlying computer system.

In addition, the present disclosure includes applying certain of the claim elements with, or by use of, a particular machine, e.g., a digital camera, which captures images used to train the hair based learning model and used to determine an image classification of the user's hair region.

In addition, the present disclosure includes specific features other than what is well-understood, routine, conventional activity in the field, or adding unconventional steps that confine the claim to a particular useful application, e.g., analyzing pixel data of an image of a hair region of a user's head to generate one or more user-specific recommendations.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 illustrates an example digital imaging and learning system configured to analyze pixel data of an image of a hair region of a user's head to generate one or more user-specific recommendations, in accordance with various embodiments disclosed herein.

FIG. 2 illustrates an example image and its related pixel data that may be used for training and/or implementing a hair based learning model, in accordance with various embodiments disclosed herein.

FIG. 3A illustrates an example set of rear head images having image classifications corresponding to features of hair of respective individuals, in accordance with various embodiments disclosed herein.

FIG. 3B illustrates an example set of front head images having image classifications corresponding to features of hair of respective individuals, in accordance with various embodiments disclosed herein.

FIG. 4 illustrates a digital imaging and learning method for analyzing pixel data of an image of a hair region of a user's head to generate one or more user-specific recommendations, in accordance with various embodiments disclosed herein.

FIG. 5A illustrates an example diagram depicting architectures and related values of an example hair based learning model, in accordance with various embodiments disclosed herein.

FIG. 5B illustrates an example diagram depicting values of the hair based learning model of FIG. 5A, in accordance with various embodiments disclosed herein.

FIG. 6 illustrates an example user interface as rendered on a display screen of a user computing device in accordance with various embodiments disclosed herein.

The Figures depict preferred embodiments for purposes of illustration only. Alternative embodiments of the systems and methods illustrated herein may be employed without departing from the principles of the invention described herein.

### DETAILED DESCRIPTION OF THE INVENTION

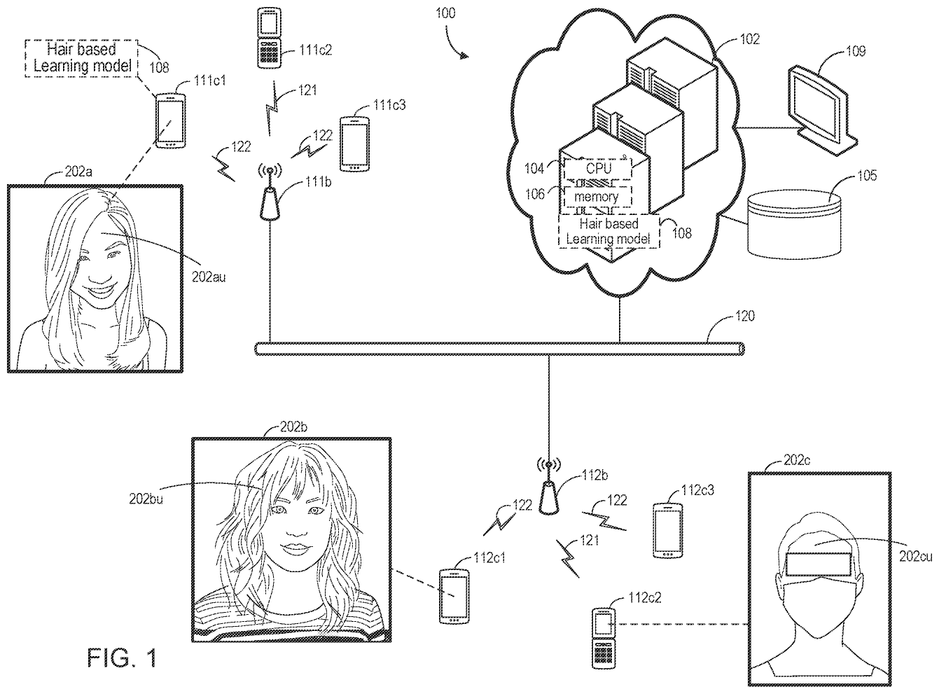

FIG. 1 illustrates an example digital imaging and learning system 100 configured to analyze pixel data of an image (e.g., any one or more of images 202a, 202b, and/or 202c) of a hair region of a user's head to generate one or more user-specific recommendations, in accordance with various embodiments disclosed herein. Generally, as referred to herein, a hair region of the user's head may refer to one or more of a front hair region, a back hair region, a side hair region, a top hair region, a full hair region, a partial hair region, or a custom defined hair region (e.g., a custom perspective region) of a hair area of a head of a given user (e.g., any of users 202au, 202bu, and/or 202cu). In the example embodiment of FIG. 1, digital imaging and learning system 100 includes server(s) 102, which may comprise one or more computer servers. In various embodiments server(s) 102 comprise multiple servers, which may comprise multiple, redundant, or replicated servers as part of a server farm. In still further embodiments, server(s) 102 may be implemented as cloud-based servers, such as a cloud-based computing platform. For example, imaging server(s) 102 may be any one or more cloud-based platform(s) such as MICROSOFT AZURE, AMAZON AWS, or the like. Server(s) 102 may include one or more processor(s) 104 as well as one or more computer memories 106. In various embodiments, server(s) 102 may be referred to herein as “imaging server(s).”

Memories 106 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memorie(s) 106 may store an operating system (OS) (e.g., Microsoft Windows, Linux, UNIX, etc.) capable of facilitating the functionalities, apps, methods, or other software as discussed herein. Memorie(s) 106 may also store a hair based learning model 108, which may be an artificial intelligence based model, such as a machine learning model, trained on various images (e.g., images 202a, 202b, and/or 202c), as described herein. Additionally, or alternatively, the hair based learning model 108 may also be stored in database 105, which is accessible or otherwise communicatively coupled to imaging server(s) 102. In addition, memories 106 may also store machine readable instructions, including any of one or more application(s) (e.g., an imaging application as described herein), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be, include, otherwise be part of, an imaging based machine learning model or component, such as the hair based learning model 108, where each may be configured to facilitate their various functionalities discussed herein. It should be appreciated that one or more other applications may be envisioned and that are executed by the processor(s) 104.

The processor(s) 104 may be connected to the memories 106 via a computer bus responsible for transmitting electronic data, data packets, or otherwise electronic signals to and from the processor(s) 104 and memories 106 in order to implement or perform the machine readable instructions, methods, processes, elements or limitations, as illustrated, depicted, or described for the various flowcharts, illustrations, diagrams, figures, and/or other disclosure herein.

Processor(s) 104 may interface with memory 106 via the computer bus to execute an operating system (OS). Processor(s) 104 may also interface with the memory 106 via the computer bus to create, read, update, delete, or otherwise access or interact with the data stored in memories 106 and/or the database 104 (e.g., a relational database, such as Oracle, DB2, MySQL, or a NoSQL based database, such as MongoDB). The data stored in memories 106 and/or database 105 may include all or part of any of the data or information described herein, including, for example, training images and/or user images (e.g., including any one or more of images 202a, 202b, and/or 202c; rear head images (e.g., 302l, 302m, 302h, 312l, 312m, 312h, 322l, 322m, and 322h); and/or front head images (e.g., 352l, 352m, 352h, 362l, 362m, 362h, 372l, 372m, and 372h), or other images and/or information of the user, including demographic, age, race, skin type, hair type, hair style, or the like, or as otherwise described herein.

Imaging server(s) 102 may further include a communication component configured to communicate (e.g., send and receive) data via one or more external/network port(s) to one or more networks or local terminals, such as computer network 120 and/or terminal 109 (for rendering or visualizing) described herein. In some embodiments, imaging server(s) 102 may include a client-server platform technology such as ASP.NET, Java J2EE, Ruby on Rails, Node.js, a web service or online API, responsive for receiving and responding to electronic requests. The imaging server(s) 102 may implement the client-server platform technology that may interact, via the computer bus, with the memories(s) 106 (including the applications(s), component(s), API(s), data, etc. stored therein) and/or database 105 to implement or perform the machine readable instructions, methods, processes, elements or limitations, as illustrated, depicted, or described for the various flowcharts, illustrations, diagrams, figures, and/or other disclosure herein.

In various embodiments, the imaging server(s) 102 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to computer network 120. In some embodiments, computer network 120 may comprise a private network or local area network (LAN). Additionally, or alternatively, computer network 120 may comprise a public network such as the Internet.

Imaging server(s) 102 may further include or implement an operator interface configured to present information to an administrator or operator and/or receive inputs from the administrator or operator. As shown in FIG. 1, an operator interface may provide a display screen (e.g., via terminal 109). Imaging server(s) 102 may also provide I/O components (e.g., ports, capacitive or resistive touch sensitive input panels, keys, buttons, lights, LEDs), which may be directly accessible via, or attached to, imaging server(s) 102 or may be indirectly accessible via or attached to terminal 109. According to some embodiments, an administrator or operator may access the server 102 via terminal 109 to review information, make changes, input training data or images, initiate training of hair based training model 108, and/or perform other functions.

As described herein, in some embodiments, imaging server(s) 102 may perform the functionalities as discussed herein as part of a “cloud” network or may otherwise communicate with other hardware or software components within the cloud to send, retrieve, or otherwise analyze data or information described herein.

In general, a computer program or computer based product, application, or code (e.g., the model(s), such as AI models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 104 (e.g., working in connection with the respective operating system in memories 106) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

As shown in FIG. 1, imaging server(s) 102 are communicatively connected, via computer network 120 to the one or more user computing devices 111c1-111c3 and/or 112c1-112c3 via base stations 111b and 112b. In some embodiments, base stations 111b and 112b may comprise cellular base stations, such as cell towers, communicating to the one or more user computing devices 111c1-111c3 and 112c1-112c3 via wireless communications 121 based on any one or more of various mobile phone standards, including NMT, GSM, CDMA, UMMTS, LTE, 5G, or the like.

Additionally or alternatively, base stations 111b and 112b may comprise routers, wireless switches, or other such wireless connection points communicating to the one or more user computing devices 111c1-111c3 and 112c1-112c3 via wireless communications 122 based on any one or more of various wireless standards, including by non-limiting example, IEEE 802.11a/b/c/g (WIFI), the BLUETOOTH standard, or the like.

Any of the one or more user computing devices 111c1-111c3 and/or 112c1-112c3 may comprise mobile devices and/or client devices for accessing and/or communications with imaging server(s) 102. Such mobile devices may comprise one or more mobile processor(s) and/or a digital camera for capturing images, such as images as described herein (e.g., any one or more of images 202a, 202b, and/or 202c). In various embodiments, user computing devices 111c1-111c3 and/or 112c1-112c3 may comprise a mobile phone (e.g., a cellular phone), a tablet device, a personal data assistance (PDA), or the like, including, by non-limiting example, an APPLE iPhone or iPad device or a GOOGLE ANDROID based mobile phone or table.

In additional embodiments, user computing devices 111c1-111c3 and/or 112c1-112c3 may comprise a retail computing device. A retail computing device may comprise a user computer device configured in a same or similar manner as a mobile device, e.g., as described herein for user computing devices 111c1-111c3, including having a processor and memory, for implementing, or communicating with (e.g., via server(s) 102), a hair based learning model 108 as described herein. Additionally, or alternatively, a retail computing device may be located, installed, or otherwise positioned within a retail environment to allow users and/or customers of the retail environment to utilize the digital imaging and learning systems and methods on site within the retail environment. For example, the retail computing device may be installed within a kiosk for access by a user. The user may then upload or transfer images (e.g., from a user mobile device) to the kiosk to implement the digital imaging and learning systems and methods described herein. Additionally, or alternatively, the kiosk may be configured with a camera to allow the user to take new images (e.g., in a private manner where warranted) of himself or herself for upload and transfer. In such embodiments, the user or consumer himself or herself would be able to use the retail computing device to receive and/or have rendered a user-specific electronic recommendation, as described herein, on a display screen of the retail computing device.

Additionally, or alternatively, the retail computing device may be a mobile device (as described herein) as carried by an employee or other personnel of the retail environment for interacting with users or consumers on site. In such embodiments, a user or consumer may be able to interact with an employee or otherwise personnel of the retail environment, via the retail computing device (e.g., by transferring images from a mobile device of the user to the retail computing device or by capturing new images by a camera of the retail computing device), to receive and/or have rendered a user-specific electronic recommendation, as described herein, on a display screen of the retail computing device.

In various embodiments, the one or more user computing devices 111c1-111c3 and/or 112c1-112c3 may implement or execute an operating system (OS) or mobile platform such as Apple's iOS and/or Google's Android operation system. Any of the one or more user computing devices 111c1-111c3 and/or 112c1-112c3 may comprise one or more processors and/or one or more memories for storing, implementing, or executing computing instructions or code, e.g., a mobile application or a home or personal assistant application, as described in various embodiments herein. As shown in FIG. 1, hair based learning model 108 and/or an imaging application as described herein, or at least portions thereof, may also be stored locally on a memory of a user computing device (e.g., user computing device 111c1).

User computing devices 111c1-111c3 and/or 112c1-112c3 may comprise a wireless transceiver to receive and transmit wireless communications 121 and/or 122 to and from base stations 111b and/or 112b. In various embodiments, pixel based images (e.g., images 202a, 202b, and/or 202c) may be transmitted via computer network 120 to imaging server(s) 102 for training of model(s) (e.g., hair based learning model 108) and/or imaging analysis as described herein.

In addition, the one or more user computing devices 111c1-111c3 and/or 112c1-112c3 may include a digital camera and/or digital video camera for capturing or taking digital images and/or frames (e.g., which can be any one or more of images 202a, 202b, and/or 202c). Each digital image may comprise pixel data for training or implementing model(s), such as AI or machine learning models, as described herein. For example, a digital camera and/or digital video camera of, e.g., any of user computing devices 111c1-111c3 and/or 112c1-112c3, may be configured to take, capture, or otherwise generate digital images (e.g., pixel based images 202a, 202b, and/or 202c) and, at least in some embodiments, may store such images in a memory of a respective user computing devices. Additionally, or alternatively, such digital images may also be transmitted to and/or stored on memorie(s) 106 and/or database 105 of server(s) 102.

Still further, each of the one or more user computer devices 111c1-111c3 and/or 112c1-112c3 may include a display screen for displaying graphics, images, text, product recommendations, data, pixels, features, and/or other such visualizations or information as described herein. In various embodiments, graphics, images, text, product recommendations, data, pixels, features, and/or other such visualizations or information may be received from imaging server(s) 102 for display on the display screen of any one or more of user computer devices 111c1-111c3 and/or 112c1-112c3. Additionally, or alternatively, a user computer device may comprise, implement, have access to, render, or otherwise expose, at least in part, an interface or a guided user interface (GUI) for displaying text and/or images on its display screen.

In some embodiments, computing instructions and/or applications executing at the server (e.g., server(s) 102) and/or at a mobile device (e.g., mobile device 111c1) may be communicatively connected for analyzing pixel data of an image of a hair region of a user's head to generate one or more user-specific recommendations, as described herein. For example, one or more processors (e.g., processor(s) 104) of server(s) 102 may be communicatively coupled to a mobile device via a computer network (e.g., computer network 120). In such embodiments, an imaging app may comprise a server app portion configured to execute on the one or more processors of the server (e.g., server(s) 102) and a mobile app portion configured to execute on one or more processors of the mobile device (e.g., any of one or more user computing devices 111c1-111c3 and/or 112c1-112c3). In such embodiments, the server app portion is configured to communicate with the mobile app portion. The server app portion or the mobile app portion may each be configured to implement, or partially implement, one or more of: (1) receiving the image captured by the digital camera; (2) determining the image classification of the user's hair; (3) generating the user-specific recommendation; and/or (4) transmitting the one user-specific recommendation to the mobile app portion.

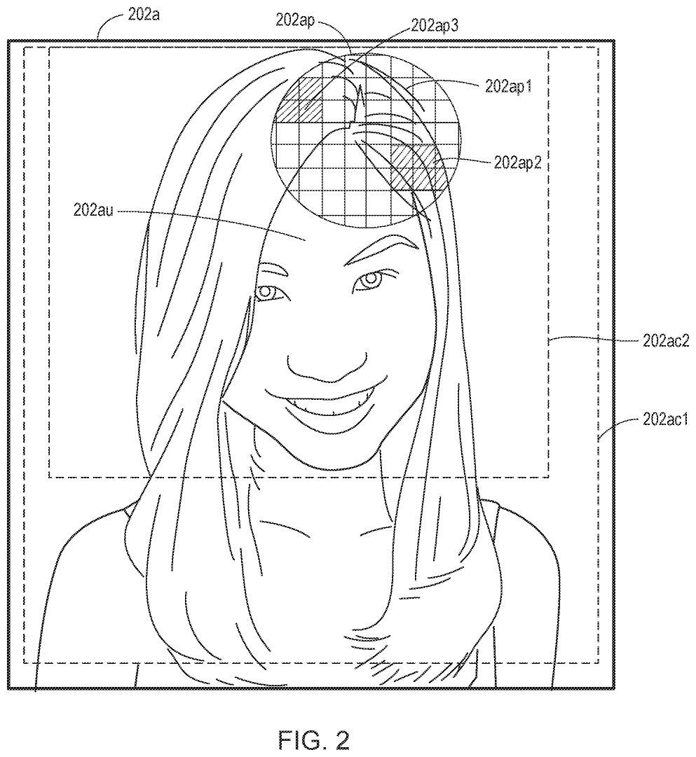

FIG. 2 illustrates an example image 202a and its related pixel data that may be used for training and/or implementing a hair based learning model, in accordance with various embodiments disclosed herein. In various embodiments, as shown for FIG. 1, image 202a may be an image captured by a user (e.g., user 202au). Image 202a (as well as images 202b and/or 202c of user 202bu and user 202cu, respectively) may be transmitted to server(s) 102 via computer network 120, as shown for FIG. 1. It is to be understood that such images may be captured by the users themselves (e.g., a “selfie image”) or, additionally or alternatively, others, such as a retailer, etc., where such images are used and/or transmitted on behalf of a user.

More generally, digital images, such as example images 202a, 202b, and 202c, may be collected or aggregated at imaging server(s) 102 and may be analyzed by, and/or used to train, a hair based learning model (e.g., an AI model such as a machine learning imaging model as describe herein). Each of these images may comprise pixel data (e.g., RGB data) comprising feature data and corresponding to each of the personal attributes of respective users (e.g., users 202au, 202bu, and 202cu), within the respective image. The pixel data may be captured by a digital camera of one of the user computing devices (e.g., one or more user computer devices 111c1-111c3 and/or 112c1-112c3).

With respect to digital images as described herein, pixel data (e.g., pixel data 202ap, 202bp, and/or 202cp of FIG. 2) comprises individual points or squares of data within an image, where each point or square represents a single pixel (e.g., each of pixel 202ap1, pixel 202ap2, and pixel 202ap3) within an image. Each pixel may be at a specific location within an image. In addition, each pixel may have a specific color (or lack thereof). Pixel color, may be determined by a color format and related channel data associated with a given pixel. For example, a popular color format includes the red-green-blue (RGB) format having red, green, and blue channels. That is, in the RGB format, data of a pixel is represented by three numerical RGB components (Red, Green, Blue), that may be referred to as a channel data, to manipulate the color of pixel's area within the image. In some implementations, the three RGB components may be represented as three 8-bit numbers for each pixel. Three 8-bit bytes (one byte for each of RGB) may be used to generate 24 bit color. Each 8-bit RGB component can have 256 possible values, ranging from 0 to 255 (i.e., in the base 2 binary system, an 8 bit byte can contain one of 256 numeric values ranging from 0 to 255). This channel data (R, G, and B) can be assigned a value from 0 to 255 that can be used to set the pixel's color. For example, three values like (250, 165, 0), meaning (Red=250, Green=165, Blue=0), can denote one Orange pixel. As a further example, (Red=255, Green=255, Blue=0) means Red and Green, each fully saturated (255 is as bright as 8 bits can be), with no Blue (zero), with the resulting color being Yellow. As a still further example, the color black has an RGB value of (Red=0, Green=0, Blue=0) and white has an RGB value of (Red=255, Green=255, Blue=255). Gray has the property of having equal or similar RGB values, for example, (Red=220, Green=220, Blue=220) is a light gray (near white), and (Red=40, Green=40, Blue=40) is a dark gray (near black).

In this way, the composite of three RGB values creates a final color for a given pixel. With a 24-bit RGB color image, using 3 bytes to define a color, there can be 256 shades of red, and 256 shades of green, and 256 shades of blue. This provides 256×256×256, i.e., 16.7 million possible combinations or colors for 24 bit RGB color images. As such, a pixel's RGB data value indicates a degree of color or light each of a Red, a Green, and a Blue pixel is comprised of. The three colors, and their intensity levels, are combined at that image pixel, i.e., at that pixel location on a display screen, to illuminate a display screen at that location with that color. In is to be understood, however, that other bit sizes, having fewer or more bits, e.g., 10-bits, may be used to result in fewer or more overall colors and ranges.

As a whole, the various pixels, positioned together in a grid pattern (e.g., pixel data 202ap), form a digital image or portion thereof. A single digital image can comprise thousands or millions of pixels. Images can be captured, generated, stored, and/or transmitted in a number of formats, such as JPEG, TIFF, PNG and GIF. These formats use pixels to store or represent the image.

With reference to FIG. 2, example image 202a illustrates a user 202au or individual. More specifically, image 202a comprises pixel data, including pixel data 202ap defining a hair region of the user's or individual's head. Pixel data 202ap includes a plurality of pixels including pixel 202ap1, pixel 202ap2, and pixel 202ap3. In example image 202a, each of pixel 202ap1, pixel 202ap2, and pixel 202ap3 are each representative of features of hair corresponding to image classifications of a hair region. Generally, in various embodiments, features of the hair of a user may comprise one or more of: (1) one or more hairs sticking out; (2) hair fiber shape or relative positioning; (3) one or more continuous hair shine bands; and/or (4) hair oiliness. Each of these classifications may be determined from or otherwise based on one or more pixels in a digital image (e.g., image 202a). For example, with respect to image 202a, pixel 202ap1 is a dark pixel (e.g., a pixel with low R, G, and B values) positioned within pixel data 202ap in a hair region at the top and side of the user's head, and, more generally, of the user's body of hair. Pixel 202ap1 is surrounded by lighter pixels, indicating that pixel 202ap1 is representative of a “frizz” image classification of hair of a user. Generally, a “frizz” image classification classifies a user's hair or hair region as having hair sticking out from the user's head.

As a further example, pixel 202ap2 is a dark pixel (e.g., a pixel with low R, G, and B values) positioned within pixel data 202ap in a hair region at the mid back to tip of the user's hair. Pixel 202ap2 is surrounded by darker pixels of other hair fibers, indicating that pixel 202ap2 is representative of an “alignment” image classification of hair of a user. Generally, an “alignment” image classification classifies a user's hair or hair region as having hair fibers shaped and positioned next to each other.

As a still further example, pixel 202ap3 is a lighter pixel (e.g., a pixel with high R, G, and B values) positioned within pixel data 202ap in a hair region at the crown of the user's head and/or mid portion of the body of the user's hair. Pixel 202ap3 is positioned with other lighter pixels that are arranged in a linear or continuous fashion through a portion of the user's hair, indicating that pixel 202ap3 is representative of a “shine” image classification of hair of a user. Generally, a “shine” image classification classifies a user's hair or hair region as having continuous shine bands of hair, e.g., running from top-to-bottom, or otherwise with the flow or styling, of the user's hair.

In addition to pixels 202ap1, 202ap2, and 202ap3, pixel data 202ap includes various other pixels including remaining portions of the user's head, including various other hair regions and/or portions of hair that may be analyzed and/or used for training of model(s), and/or analysis by used of already trained models, such as hair based training model 108 as described herein. For example, pixel data 202ap further includes pixels representative of features of hair corresponding to various image classifications, including, but not limited to (1) a hair frizz image classification (e.g., as described for pixel 202ap1), (2) a hair alignment image classification (e.g., as described for pixel 202ap2), (3) a hair shine image classification (e.g., as described for pixel 202ap3), (4) a hair oiliness classification (e.g., comprising one or more lighter pixels of a hair region of the user's head within pixel data 202ap); (5) a hair volume classification (e.g., comprising a greater number of hair based pixels compared to other pixels in the image within pixel data 202ap); (6) a hair color classification (e.g., based on the RGB colors of one or more pixels within pixel data 202ap); and/or (7) a hair type classification (e.g., based on various positioning of pixels relative to one another in within pixel data 202ap, or otherwise an image, that indicate a hair type and/or attribute that comprises, e.g., the shape, curl, straightness, coil type, style, or otherwise characteristic of a user's hair), and other classifications and/or features as shown in FIG. 2.

A digital image, such as a training image, an image as submitted by users, or otherwise a digital image (e.g., any of images 202a, 202b, and/or 202c), may be or may comprise a cropped image. Generally, a cropped image is an image with one or more pixels removed, deleted, or hidden from an originally captured image. For example, with reference to FIG. 2, image 202a represents an original image. Cropped portion 202ac1 represents a first cropped portion of image 202a representing a full hair crop that removes portions of the user (outside of cropped portion 202ac1) not including the user's body of hair. As a further example, cropped portion 202ac2 represents a second cropped portion of image 202a representing a head crop that removes portions of the image (outside of cropped portion 202ac2) not comprising the user's head and related hair region. In various embodiments, analyzing and/or use of cropped images for training yields improved accuracy of a hair based learning model. It also improves the efficiency and performance of the underlying computer system in that such system processes, stores, and/or transfers smaller size digital images.

It is to be understood that the disclosure for image 202a of FIG. 2 applies the same or similarly for other digital images described herein, including, for example, images 202b and 202c, where such images also comprise pixels that may be analyzed and/or used for training of model(s) as described herein.

In addition, digital images of a user's hair, as described herein, may depict various hair statuses, which may be used to train hair based learning models across a variety of different users having a variety of different hair statuses. For example, as illustrated for images 202a, 202b, and 202c, the hair regions of the users (e.g., 202au, 202bu, and 202cu) of these images comprise hair statuses of the user's hair identifiable with the pixel data of the respective images. These hair statuses include, for example, a hair tied-up status (e.g., as depicted in image 202c for user 202cu), a hair open status (e.g., as depicted in images 202a and 202b for users 202au and 202bu, respectively), a hair styled status (e.g., as depicted in image 202b for user 202bu), and/or a non-styled status (e.g., as depicted in image 202a for user 202au).

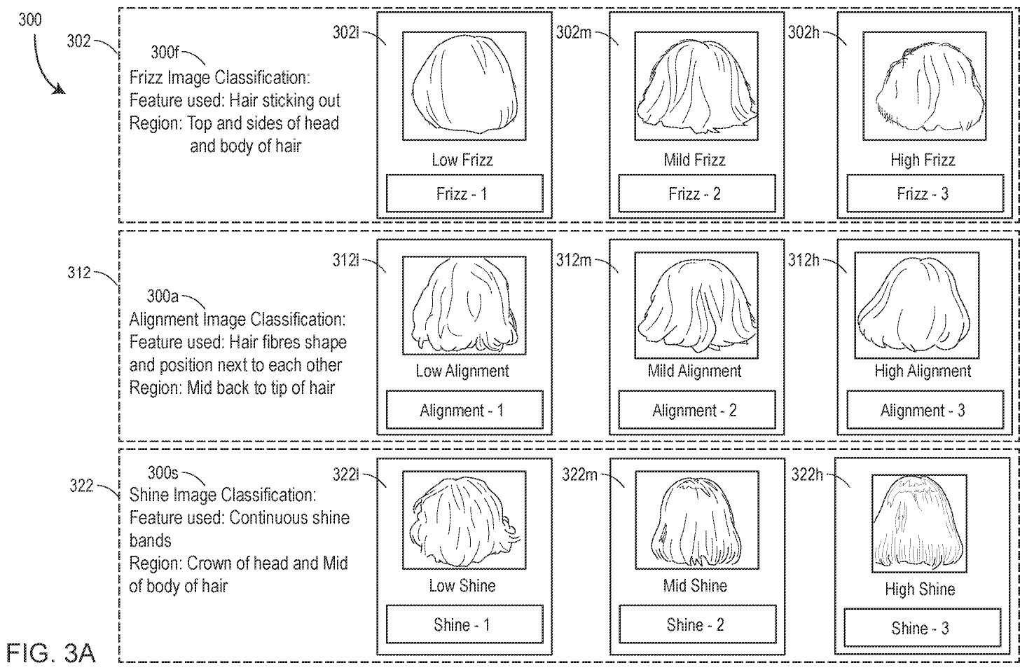

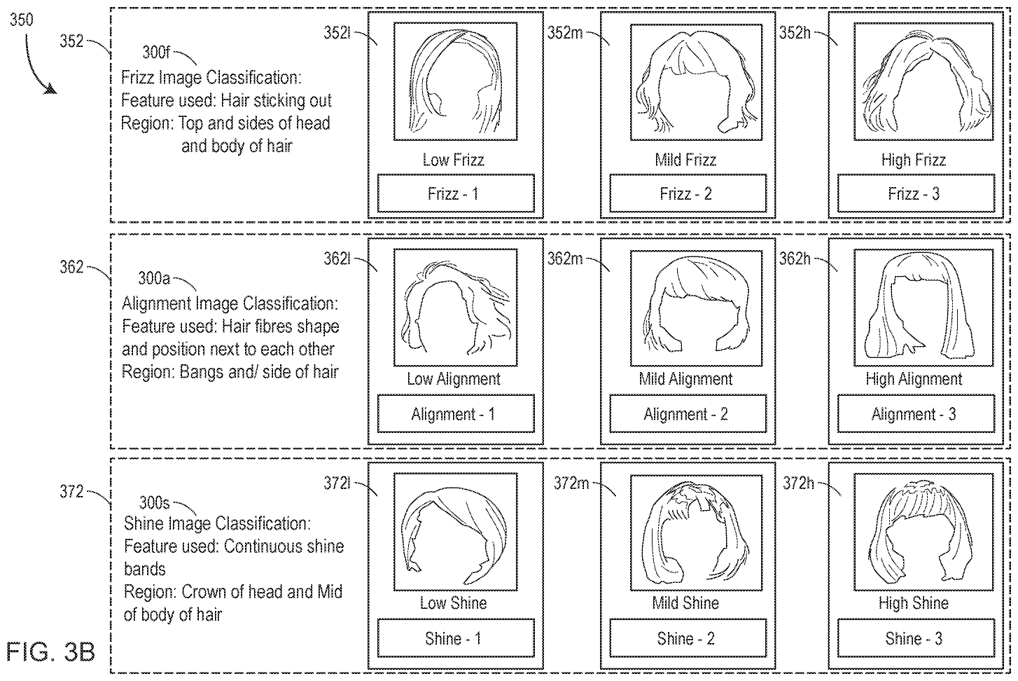

In various embodiments, digital images (e.g., images 202a, 202b, and 202c), whether used as training images depicting individuals, or used as images depicting users or individuals for analysis and/or recommendation, may comprise multiple angles or perspectives depicting hair regions of each of the respective individual or the user. The multiple angles or perspectives may include different views, positions, closeness of the user and/or backgrounds, lighting conditions, or otherwise environments in which the user is positioned against in a given image. For example, each of FIGS. 3A and 3B comprise sets of rear head images (e.g., 302l, 302m, 302h, 312l, 312m, 312h, 322l, 322m, and 322h) and front head images (e.g., 352l, 352m, 352h, 362l, 362m, 362h, 372l, 372m, and 372h) that represent different angles or perspectives depicting hair regions of respective individuals and/or users. More specifically, FIG. 3A illustrates an example set 300 of rear head images (302l, 302m, 302h, 312l, 312m, 312h, 322l, 322m, and 322h) having image classifications (e.g., 300f, 300a, and 300s) corresponding to features of hair of respective individuals, in accordance with various embodiments disclosed herein. FIG. 3B illustrates an example set 352 of front head images (352l, 352m, 352h, 362l, 362m, 362h, 372l, 372m, and 372h) having image classifications (e.g., 300f, 300a, and 300s) corresponding to features of hair of respective individuals, in accordance with various embodiments disclosed herein. Such images maybe used for training a hair based learning model, or for analysis, and/or user-specific recommendations, as described herein.

As shown in each of FIGS. 3A and 3B, rear head images (302l, 302m, 302h, 312l, 312m, 312h, 322l, 322m, and 322h) and front head images (352l, 352m, 352h, 362l, 362m, 362h, 372l, 372m, and 372h) comprise head cropped images, that is, images that have been cropped to include a head portion of a user or individual (e.g., as described herein for cropped portion 202ac2 of image 202a). In some embodiments, digital images, such as training images and/or images as provided by users or otherwise (e.g., any of images 202a, 202b, and/or 202c), may be or comprise cropped images depicting hair with at least one or more features, such as facial features of the user removed. For example, front head images (352l, 352m, 352h, 362l, 362m, 362h, 372l, 372m, and 372h) of FIG. 3B depict head cropped images having facial images removed. Additionally, or alternatively, images may be sent as cropped or that otherwise include extracted or depicted hair regions of a user without depicting personal identifiable information (PII) of the user. For example, image 202c of FIG. 1 includes an example of a user depicted wearing a mask (to cover her face) and with a cropped or redacted portion covering or hiding her eyes. Such features provides a security improvement, i.e., where the removal of PII (e.g., facial features) provides an improvement over prior systems because cropped or redacted images, especially ones that may be transmitted over a network (e.g., the Internet), are more secure without including PII information of a user. Importantly, the systems and methods described herein may operate without the need for such non-essential information, which provides an improvement, e.g., a security and a performance improvement, over prior system.

Although FIGS. 3A and 3B depict and describe cropped images, it is to be understood, however, that other image types including, but not limited to, original, non-cropped images (e.g., original image 202a) and/or full hair cropped (e.g., cropped portion 202ac1 of image 202a) may be used or substituted as well.

With reference to FIGS. 3A and 3B, each of the images of image set 302 and image set 352 have been classified, assigned, or otherwise identified as having a frizz image classification 300f. A “frizz” image classification indicates that a user's hair or hair region has feature(s) (e.g., identifiable within pixel data of a given image) comprises hair sticking out from a head or hair area of user. Determination that a given image classifies as a frizz based image may include analyzing the image (and its related pixel data, e.g., pixel 202ap1 of image 202a), including at a hair region at the top and side of a user's head, and, more generally, of the user's body of hair. It is to be understood that, additionally or alternatively, other hair regions or areas or user's head may be analyzed as well.

Each of the classifications described herein, including classifications corresponding to one or more features of hair, may also include sub-classifications or different degrees of a given feature (e.g., hair frizz, alignment, shine, oiliness, etc.) for a given classification. For example, with respect to image set 302 and image set 352, each of rear head image 302l and front head image 352l has been classified, assigned, or has otherwise been identified as having a sub-classification or degree of “low frizz” (having a grade or value of frizz 1) indicating that each of rear head image 302l and front head image 352l, as determined from respective pixel data, indicates low or no hair sticking out from the user's head as depicted in the respective image. Likewise, each of rear head image 302m and front head image 352m has been classified, assigned, or is otherwise identified as having a sub-classification or degree of “mid frizz” (having a grade or value of frizz 2) indicating that each of rear head image 302m and front head image 352m, as determined from respective pixel data, indicates a medium amount of hair sticking out from the user's head as depicted in the respective image. Finally, each of rear head image 302h and front head image 352h has been classified, assigned, or is otherwise identified as having a sub-classification or degree of “high frizz” (having a grade or value of frizz 3) indicating that each of rear head image 302h and front head image 352h, as determined from respective pixel data, indicates a high amount of hair sticking out from the user's head as depicted in the respective image. Each of the images of image set 302 and image set 352, with their respective features indicating a specific classification (i.e., frizz image classification) and related sub-classifications or degrees, may be used to train or retrain a hair based training model (e.g., hair based training model 108) in order to make the hair based training model more accurate at detecting, determining, or predicting classifications and/or frizz based features (and, in various embodiments, degrees thereof) in images (e.g., user images 202a, 202b, and/or 202c) provided to the hair based training model.

With further reference to FIGS. 3A and 3B, each the images of image set 312 and image set 362 have been classified, assigned, or otherwise identified as having an alignment image classification 300a. An “alignment” image classification indicates that a user's hair or hair region has feature(s) (e.g., identifiable within pixel data of a given image) has hair fibers shaped and positioned next to each other. Determination that a given image classifies as an alignment based image may include analyzing the image (and its related pixel data, e.g., pixel 202ap2 of image 202a), including at the mid back to tip of the user's hair. It is to be understood that, additionally or alternatively, other hair regions or areas or user's head may be analyzed as well.

With respect to image set 312 and image set 362, each of rear head image 312l and front head image 362l has been classified, assigned, or has otherwise been identified as having a sub-classification or degree of “low alignment” (having a grade or value of alignment 1) indicating that each of rear head image 312l and front head image 362l, as determined from respective pixel data, indicates low or no alignment of the user's hair as depicted in the respective image. Likewise, each of rear head image 312m and front head image 362m has been classified, assigned, or is otherwise identified as having a sub-classification or degree of “mid alignment” (having a grade or value of alignment 2) indicating that each of rear head image 312m and front head image 362m, as determined from respective pixel data, indicates a medium amount of alignment of the user's hair as depicted in the respective image. Finally, each of rear head image 312h and front head image 362h has been classified, assigned, or is otherwise identified as having a sub-classification or degree of “high alignment” (having a grade or value of alignment 3) indicating that each of rear head image 312h and front head image 362h, as determined from respective pixel data, indicates a high amount of alignment of the user's hair as depicted in the respective image. Each of the images of image set 312 and image set 362, with their respective features indicating a specific classification (i.e., alignment image classification) and related sub-classifications or degrees, may be used to train or retrain a hair based training model (e.g., hair based training model 108) in order to make the hair based training model more accurate at detecting, determining, or predicting classifications and/or alignment based features (and, in various embodiments, degrees thereof) in images (e.g., user images 202a, 202b, and/or 202c) provided to the hair based training model.

With further reference to FIGS. 3A and 3B, the images of image set 322 and image set 372 have been classified, assigned, or otherwise identified as having a shine image classification 300s. A “shine” image classification indicates that a user's hair or hair region has feature(s) (e.g., identifiable within pixel data of a given image) has continuous shine bands of hair, e.g., running from top-to-bottom, or otherwise with the flow or styling, of the user's hair. Determination that a given image classifies as a shine based image may include analyzing the image (and its related pixel data, e.g., pixel 202ap2 of image 202a), including at the crown of the user's head and/or mid portion of the body of the user's hair. It is to be understood that, additionally or alternatively, other hair regions or areas or user's head may be analyzed as well.

With respect to image set 322 and image set 372, each of rear head image 322l and front image 372l has been classified, assigned, or has otherwise been identified as having a sub-classification or degree of “low sine” (having a grade or value of shine 1) indicating that each of rear head image 322l and front image 372l, as determined from respective pixel data, indicates low or no shine or shine bands of the user's hair as depicted in the respective image. Likewise, each of rear head image 322m and front image 372m has been classified, assigned, or is otherwise identified as having a sub-classification or degree of “mid shine” (having a grade or value of sine 2) indicating that each of rear head image 322m and front image 372m, as determined from respective pixel data, indicates a medium amount of shine or shine bands of the user's hair as depicted in the front image 372l image. Finally, each of rear head image 322h and front image 372l has been classified, assigned, or is otherwise identified as having a sub-classification or degree of “high shine” (having a grade or value of shine 3) indicating that each of rear head image 322h and front image 372l, as determined from respective pixel data, indicates a high amount of shine or shine bands of the user's hair as depicted in the respective image. Each of the images of image set 322 and image set 372, with their respective features indicating a specific classification (i.e., shine image classification) and related sub-classifications or degrees, may be used to train or retrain a hair based training model (e.g., hair based training model 108) in order to make the hair based training model more accurate at detecting, determining, or predicting classifications and/or shine based features (and, in various embodiments, degrees thereof) in images (e.g., user images 202a, 202b, and/or 202c) provided to the hair based training model.

While each of FIGS. 3A and 3B illustrates three image classifications for image features, including frizz, alignment, and shine, it is to be understood that additional classifications (e.g., such as oiliness) are similarly contemplated herein. In addition, the various classifications may be used together, where a single image may be classified as having, or being otherwise identified with, multiple image classifications. For example, in various embodiments, computing instructions may further cause one or more processors (e.g., of server(s) 102 and/or a user computing device) to analyze, by a hair based learning model, an image captured by the digital camera to determine a second image classification of a user's hair region as selected from one or more image classifications of the hair based learning model. A user-specific recommendation, as described herein, may further based on the second image classification of the user's hair region. Third, fourth, etc. image classifications may also be assigned and/or used for a given image, as well.

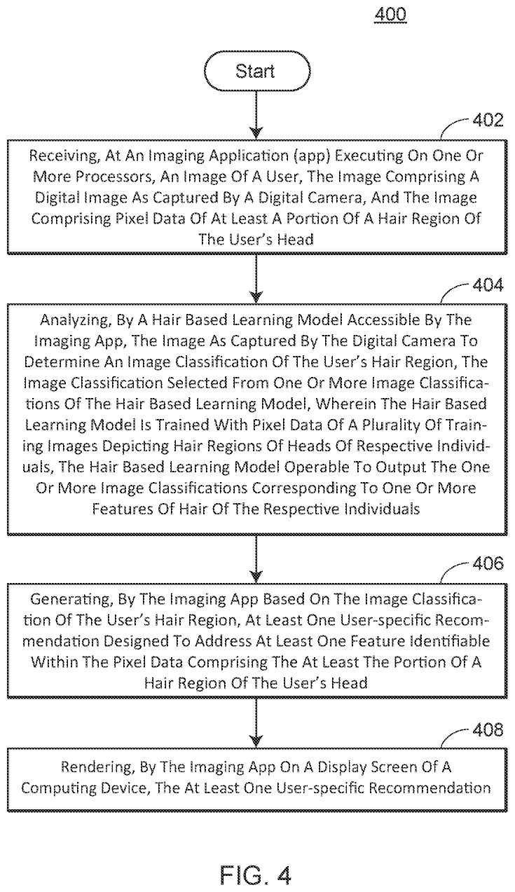

FIG. 4 illustrates a digital imaging and learning method 400 for analyzing pixel data of an image (e.g., any of images 202a, 202b, and/or 202c; rear head images (302l, 302m, 302h, 312l, 312m, 312h, 322l, 322m, and/or 322h; and/or front head images (352l, 352m, 352h, 362l, 362m, 362h, 372l, 372m, and/or 372h) of a hair region of a user's head to generate one or more user-specific recommendations, in accordance with various embodiments disclosed herein. Images, as used with method 400, and more generally as described herein, are pixel based images as captured by a digital camera (e.g., a digital camera of user computing device 111c1). In some embodiments an image may comprise or refer to a plurality of images such as a plurality of images (e.g., frames) as collected using a digital video camera. Frames comprise consecutive images defining motion, and can comprise a movie, a video, or the like.

At block 402, method 400 comprises receiving, at an imaging application (app) executing on one or more processors (e.g., one or more processor(s) 104 of server(s) 102 and/or processors of a computer user device, such as a mobile device), an image of a user (e.g., user 202au). The image comprises a digital image as captured by a digital camera (e.g., a digital camera of user computing device 111c1). The image comprises pixel data of at least a portion of a hair region of the user's head;

At block 404, method 400 comprises analyzing, by a hair based learning model (e.g., hair based learning model 108) accessible by the imaging app, the image as captured by the digital camera to determine an image classification of the user's hair region. The image classification is selected from one or more image classifications (e.g., any one or more of alignment image classification 300f, alignment image classification 300a, and/or shine image classification 300s) of the hair based learning model.

A hair based learning model (e.g., training hair based learning model 108) as referred to herein in various embodiments, is trained with pixel data of a plurality of training images (e.g., any of images 202a, 202b, and/or 202c; rear head images (302l, 302m, 302h, 312l, 312m, 312h, 322l, 322m, and/or 322h; and/or front head images (352l, 352m, 352h, 362l, 362m, 362h, 372l, 372m, and/or 372h) depicting hair regions of heads of respective individuals. The hair based learning model is configured to, or is otherwise operable to, output the one or more image classifications corresponding to one or more features of hair of respective individuals.

In various embodiments, hair based learning model (e.g., training hair based learning model 108) is an artificial intelligence (AI) based model trained with at least one AI algorithm. Training of hair based learning model 108 involves image analysis of the training images to configure weights of hair based learning model 108, and its underlying algorithm (e.g., machine learning or artificial intelligence algorithm) used to predict and/or classify future images. For example, in various embodiments herein, generation of hair based learning model 108 involves training hair based learning model 108 with the plurality of training images of a plurality of individuals, where each of the training images comprise pixel data and depict hair regions of heads of respective individuals. In some embodiments, one or more processors of a server or a cloud-based computing platform (e.g., imaging server(s) 102) may receive the plurality of training images of the plurality of individuals via a computer network (e.g., computer network 120). In such embodiments, the server and/or the cloud-based computing platform may train the hair based learning model with the pixel data of the plurality of training images.

In various embodiments, a machine learning imaging model, as described herein (e.g. hair based learning model 108), may be trained using a supervised or unsupervised machine learning program or algorithm. The machine learning program or algorithm may employ a neural network, which may be a convolutional neural network, a deep learning neural network, or a combined learning module or program that learns in two or more features or feature datasets (e.g., pixel data) in a particular areas of interest. The machine learning programs or algorithms may also include natural language processing, semantic analysis, automatic reasoning, regression analysis, support vector machine (SVM) analysis, decision tree analysis, random forest analysis, K-Nearest neighbor analysis, naïve B ayes analysis, clustering, reinforcement learning, and/or other machine learning algorithms and/or techniques. In some embodiments, the artificial intelligence and/or machine learning based algorithms may be included as a library or package executed on imaging server(s) 102. For example, libraries may include the TENSORFLOW based library, the PYTORCH library, and/or the SCIKIT-LEARN Python library.

Machine learning may involve identifying and recognizing patterns in existing data (such as identifying features of hair, hair types, hair styles, or other hair related features in the pixel data of image as described herein) in order to facilitate making predictions or identification for subsequent data (such as using the model on new pixel data of a new image in order to determine or generate a user-specific recommendation designed to address at least one feature identifiable within the pixel data comprising the at least the portion of a hair region of the user's head).

Machine learning model(s), such as the hair based learning model described herein for some embodiments, may be created and trained based upon example data (e.g., “training data” and related pixel data) inputs or data (which may be termed “features” and “labels”) in order to make valid and reliable predictions for new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on the server, computing device, or otherwise processor(s), to predict, based on the discovered rules, relationships, or model, an expected output.

In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction accuracy when given test level or production level data or inputs, is generated.

Supervised learning and/or unsupervised machine learning may also comprise retraining, relearning, or otherwise updating models with new, or different, information, which may include information received, ingested, generated, or otherwise used over time. The disclosures herein may use one or both of such supervised or unsupervised machine learning techniques.

In various embodiments, a hair based learning model (e.g., training hair based learning model 108) may be trained, by one or more processors (e.g., one or more processor(s) 104 of server(s) 102 and/or processors of a computer user device, such as a mobile device) with the pixel data of a plurality of training images (e.g., any of images 202a, 202b, and/or 202c; rear head images (302l, 302m, 302h, 312l, 312m, 312h, 322l, 322m, and/or 322h; and/or front head images (352l, 352m, 352h, 362l, 362m, 362h, 372l, 372m, and/or 372h). In various embodiments, a hair based learning model (e.g., training hair based learning model 108) is configured output one or more hair types corresponding to the hair regions of heads of respective individuals.

In various embodiments, the one or more hair types may correspond to one or more user demographics and/or ethnicities, e.g., as typically associated with, or otherwise naturally occurring for, different races, genomes, and/or geographic locations associated with such demographics and/or ethnicities. Still further, each of the one or more hair types may define specific hair type attributes. In such embodiments, a hair type and/or its attribute(s) may comprise any one or more, e.g., the shape, curl, straightness, coil type, style, or otherwise characteristic or structure of a user's hair. A training hair based learning model (e.g., training hair based learning model 108) may determine an image classification (e.g., frizz image classification 300f, alignment image classification 300a, and/or shine image classification 300s) of the user's hair region based on a hair type or specific hair type attribute(s) of at least a portion of a hair region of the user's head.

In various embodiments, image analysis may include training a machine learning based model (e.g., the hair based learning model 108) on pixel data of images depicting hair regions of heads of respective individuals. Additionally, or alternatively, image analysis may include using a machine learning imaging model, as previously trained, to determine, based on the pixel data (e.g., including their RGB values) one or more images of the individual(s), an image classification of the user's hair region. The weights of the model may be trained via analysis of various RGB values of individual pixels of a given image. For example, dark or low RGB values (e.g., a pixel with values R=25, G=28, B=31) may indicate regions of an image where hair is present. For example, a dark toned RGB value (e.g., a pixel with values R=215, G=90, B=85) may indicate the presence of hair within an image hair that has a black, brown, or “dirty” blonde color tone. Likewise, a slightly lighter RGB values (e.g., a pixel with R=181, G=170, and B=191) may indicate the presence of hair within an image that has a lighter blonde, or in some cases gray or white, color tone. Still further, RGB values (e.g., a pixel with R=199, G=200, and B=230) may indicate white background, areas of the sky, or other such background or environment toned colors. Together, when a pixel with having hair toned RGB is positioned within a given image, or is otherwise surrounded by, a group or set of pixels having background or environment toned colors, then a hair based training model (e.g., hair based training model 108 can determine an image classification of a user's hair region, as identified within the given image. In this way, pixel data (e.g., detailing hair regions of heads of respective individuals) of 10,000s training images may be used to train or use a machine learning imaging model to determine an image classification of the user's hair region.

In various embodiments, training hair based learning model 108 may be an ensemble model comprising multiple models or sub-models that are configured to operate together. For example, in some embodiments, each model be trained to identify or predict an image classification for a given image, where each model may output or determine a classification for an image such that a given image may be identified, assigned, determined, or classified with one or more image classifications.

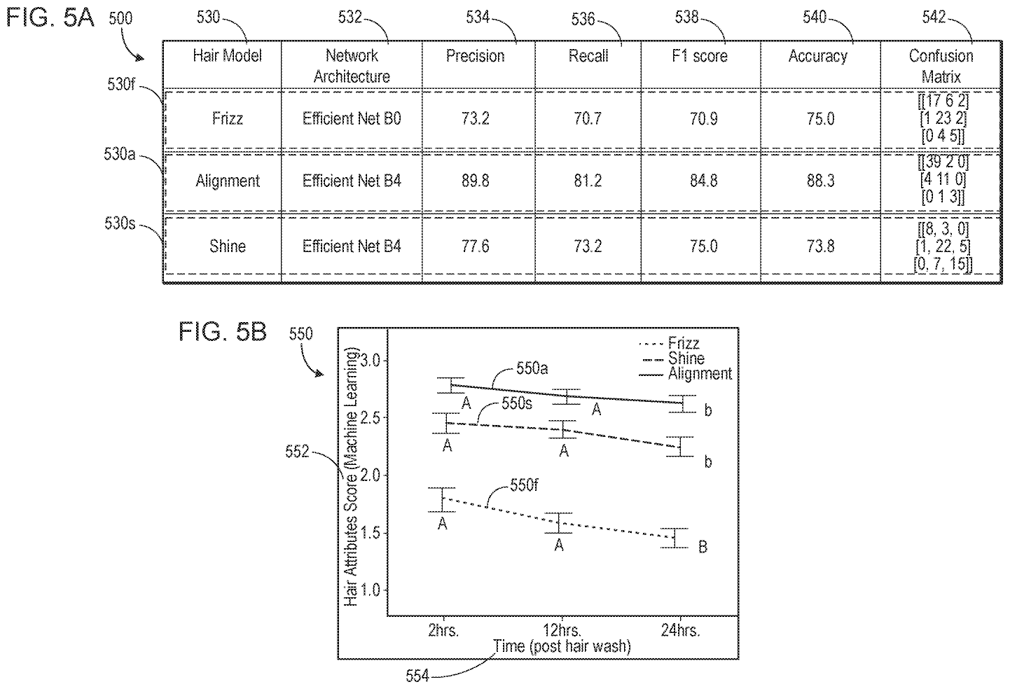

FIG. 5A illustrates an example diagram depicting a model architecture 500 and its related values of an example hair based learning model (e.g., hair based learning model 108), in accordance with various embodiments disclosed herein. In the example of FIG. 5A, a hair based learning model is an ensemble model having a model architecture 500 comprising a three hair models 530, including each of hair models 530f, 530a, and 530s. Hair model 530f is a hair frizz based model trained or otherwise configured to identify, assign, determine, or classify an image as having a frizz image classification 300f as described herein. Likewise, hair model 530a is a hair alignment based model trained or otherwise configured to identify, assign, determine, or classify an image as having an alignment image classification 300a as described herein. Still further, hair model 530s is a hair alignment based model trained or otherwise configured to identify, assign, determine, or classify an image as having a shine image classification 300s as described herein. Each of the models may be a portion of hair based learning model 108, and may operate sequentially, or in parallel, to identify, assign, determine, or classify an image as described herein. Such models may be trained on original images and/or cropped images, including, for example, any of images 202a, 202b, and/or 202c; rear head images (302l, 302m, 302h, 312l, 312m, 312h, 322l, 322m, and/or 322h); and/or front head images (352l, 352m, 352h, 362l, 362m, 362h, 372l, 372m, and/or 372h), as described herein.

In the example of FIG. 5A, each of the hair models 530f, 530a, and 530s has a network architecture 532 comprising an Efficient Net architecture. Generally, an Efficient Net is a convolutional neural network (CNN) architecture comprising a scaling algorithm that uniformly scales all dimensions of an image (e.g., depth, width, resolution of a digital image) using a compound coefficient. That is, the Efficient Net scaling algorithm uniformly scales a model's network values (e.g., a model's weights values), such as a model's width, depth, and resolution values, with a set of fixed scaling coefficients. The coefficients can be adjusted to adapt the efficiency of a given network architecture, and, therefore, the efficiency or impact of the underlying computing system (e.g., imaging server(s) 102 and/or user computing device, e.g., 111c1). For example, to decrease computational resources by 2^{N}, as used by an underlying computing system, a network architecture's depth may be decreased by α^{N}, its width may be decreased by β^{N}, and its image size may be decreased by γ^{N}, where each of α, β, and γ are constant coefficients applied to the network architecture, and may be determined, e.g., by a grid search or review of an original model.

In various embodiments, an Efficient Net architecture (e.g., of any of hair models 530f, 530a, and 530s) may use a compound coefficient ϕ to uniformly scale each of network width, depth, and resolution in a principled way. In such embodiments, compound scaling may be used based on image size, where, e.g., larger images may require a network of a model to have more layers to increase the receptive field and more channels (e.g., RGB channels of a pixel) to capture fine-grained patterns within a larger image comprising more pixels.

Hair model 530f uses an Efficient Net B0 network architecture. Efficient Net B0 is a baseline model. The Efficient Net B0 baseline model may adjusted with compound coefficient ϕ to increase the model size, and achieve accuracy gains (e.g., the ability of the model to more accurately predict or classify a given image). In contrast, each of hair model 530a and hair model 530s have had compound coefficient ϕ increased to a value of 4, resulting in their use of an Efficient Net B4 network architecture. Accordingly, in the embodiment of FIG. 5A, each of each of hair model 530a and hair model 530s have increased model sizes (dimensions) compared to hair model 530f.

As shown in the example of FIG. 5A, each of hair models 530f, 530a, and 530s, provide multi-class classification (e.g., an ensemble model), of hair visual attributes (e.g. frizz, alignment, and shine). In the example of FIG. 5A, the model was trained with hundreds of hair extracted rear head images (e.g., images 302l, 302m, 302h, 312l, 312m, 312h, 322l, 322m, and/or 322h) and front head images (e.g., images 352l, 352m, 352h, 362l, 362m, 362h, 372l, 372m, and/or 372h). Hair models 530f, 530a, and 530s were trained and/or configured to capture both male and female hair features. Following training, hair models 530f, 530a, and 530s achieve approximately 73%, 90% and 78% precision (534); 71%, 81%, 73% recall (536); 71%, 85%, and 75% F1 scores (538); 75%, 83%, and 74% accuracy (540), for each of frizz, alignment and shine classifications, respectively. Generally, precision (534) defines how precise a model is by comparing predicted positive results to actual positive results. Accuracy (540) values are based on confusion matrix (542) values, where a confusion matrix is a table defining performance of a classification model (or “classifier”) on a set of test data for which the true values are known. Each row in a confusion matrix represents an actual class, while each column represents a predicted class. Comparison of the row and column values yields correct results as compared to false positive and false negatives. Accuracy (540) values are based on the summation or evaluation of the values of confusion matrix (542). Recall (536) defines how many of the actual positives the model captured. F1 score (538) is derived from both precision (534) and recall (536), and measures the balance between precision and recall, and allows determinations of uneven class distribution across the models.

Although the example of FIG. 5A uses Efficient Net models and architectures, it is to be understood, however, that other AI model architectures and/or types, such as other types of CNN architectures, may be used instead of Efficient Net architectures. In addition, while an ensemble model or multi-class model is shown, it is to be understood that a one or more models may be used, including a single model based on a single AI model, such as a single Efficient Net neural network architecture or other AI algorithm.

With reference to FIG. 4, at block 406, method 400 comprises generating, by the imaging app based on the image classification of the user's hair region, at least one user-specific recommendation. The user-specific recommendation is generated or designed to address at least one feature identifiable within the pixel data comprising at least the portion of a hair region of the user's head. For example, in various embodiments, a user-specific recommendation may include a recommended wash frequency specific to the user. The washing frequency may comprise a number of times to wash, one or more times or periods over a day, week, etc. to wash, suggestions as to how to wash, etc.

Additionally, or alternatively, a user-specific recommendation may comprise a hair quality score as determined based on the pixel data of at least a portion of a hair region of the user's head and one or more image classifications selected from the one or more image classifications of a hair based learning model (e.g., hair based learning model 108). For example, FIG. 5B illustrates an example diagram depicting values (e.g., including values indicating a hair quality score) of the hair based learning model of FIG. 5A, in accordance with various embodiments disclosed herein. It is to be understood that the values of FIG. 5B may also represent, more generally, values (e.g., including values indicating a hair quality scores) as provided by a hair based learning model (e.g., hair based learning model 108).

With reference to FIG. 5B, various hair attributes scores (552) are depicted. Hair attributes scores (552) are a type of hair quality score. Hair attributes scores (552) may each have been output by a machine-learning based model, including frizz values 550f as output by hair model 530f, alignment values 550a as output by hair model 530a, and shine values 550s as output by hair model 530s. A hair quality score (e.g., of hair attributes scores (552)) may be assigned, shown, or provided to a user based a grade, degree, or severity (or lack thereof) of frizz, alignment, shine, oiliness, and/or other hair attributes. Generally, a hair quality score may indicate how good or bad a user's hair is across these attributes. In addition, a hair quality score can either be for an individual hair attribute e.g. hair shine, or can be a holistic score incorporating, or based, on one or more hair attributes (e.g., frizz, shine, alignment, oiliness, etc.). Higher scores typically indicate more favorable attributes.

As shown in FIG. 5B, each of frizz values 550f, alignment values 550a, and shine values 550s are distributed across time (554), with a post-hair wash time defining the time following when a user washed his or her hair. Hair quality scores (e.g., of hair attributes scores (552) generally degrade overtime, indicating to a user that frequent hair washing improves attributes of a user's hair (e.g., frizz, alignment, shine, oiliness, and/or other hair attributes). For example, as exemplified by FIG. 5B, hair quality scores (e.g., hair attributes scores (552)) for each of hair frizz, alignment, and shine was much more reduced at 24 hours post hair wash, compared to 2 hour an d12 hour periods post wash, suggesting endogenous factors such as sebum, sweat, and/or exogenous factors, such as wind, humidity and product-type used etc., had an impact on the quality and/or appearance of hair, which may lead to an unsatisfactory hair look and/or hair quality attributes (e.g., frizz, alignment, shine, oiliness, and/or other hair attributes).

With reference to FIG. 4, at block 408, method 400 comprises rendering, by the imaging app on a display screen of a computing device (e.g., user computing device 111c1), the at least one user-specific recommendation. The user-specific recommendation may be generated by a user computing device (e.g., user computing device 111c1) and/or by a server (e.g., imaging server(s) 102). For example, in some embodiments imaging server(s) 102, as described herein for FIG. 1, may analyze a user image remote from a user computing device to determine the determine an image classification of the user's hair region and/or the user-specific recommendation designed to address at least one feature identifiable within the pixel data comprising the at least the portion of a hair region of the user's head. For example, in such embodiments imaging server or a cloud-based computing platform (e.g., imaging server(s) 102) receives, across computer network 120, the at least one image comprising the pixel data of at the least a portion of a hair region of the user's head. The server or a cloud-based computing platform may then execute hair based learning model (e.g., hair based learning model 108) and generate, based on output of the hair based learning model (e.g., hair based learning model 108), the user-specific recommendation. The server or a cloud-based computing platform may then transmit, via the computer network (e.g., computer network 120), the user-specific recommendation to the user computing device for rendering on the display screen of the user computing device.

In some embodiments, a user may submit a new image to the hair based learning model for analysis as described herein. In such embodiments, one or more processors (e.g., imaging server(s) 102 and/or a user computing device, such as user computing device 111c1) may receive, analyze, and/or record, in one or more memories communicatively coupled to the one or more processors, an image of a user as captured by a digital camera at a first time for tracking changes to user's hair region over time. In addition, the one or more processors (e.g., imaging server(s) 102 and/or a user computing device, such as user computing device 111c1) may receive a second image of the user. The second image may have been captured by the digital camera at a second time. The second image may comprise pixel data of at least a portion of a hair region of the user's head. Still further, the one or more processors (e.g., imaging server(s) 102 and/or a user computing device, such as user computing device 111c1) may analyze, by the hair based learning model, the second image captured by the digital camera to determine, at the second time, a second image classification of the user's hair region as selected from the one or more image classifications of the hair based learning model. In addition, the one or more processors (e.g., imaging server(s) 102 and/or a user computing device, such as user computing device 111c1) may generate, based on a comparison of the image and the second image or the classification or the second classification of the user's hair region, a new user-specific recommendation or comment (e.g., message) regarding at least one feature identifiable within the pixel data of the second image comprising the at least the portion of a hair region of the user's head. The one or more processors (e.g., imaging server(s) 102 and/or a user computing device, such as user computing device 111c1) may render, on a display screen of a computing device, the new user-specific recommendation or comment.

In various embodiments, a user-specific recommendation or comment (e.g., including a new user-specific recommendation or comment) may comprise a textual, visual, or virtual recommendation, e.g., displayed on the display screen of a user computing device (e.g., user computing device 111c1). Such recommendation may include a graphical representation of the user and/or user's hair as annotated with one or more graphics or textual renderings corresponding to user-specific attributes (e.g., frizz, alignment, shine, etc.). In embodiments comprising including a new user-specific recommendation or comment, such new user-specific recommendation or comment may comprise a comparison of the at least the portion a hair region of the user's head between the first time and the second time.

In some embodiments, a user-specific recommendation may be displayed on a display screen of the computing device (e.g., user computing device 111c1) with instructions for treating the at least one feature identifiable in the pixel data (e.g., of an image) comprising the at least the portion of a hair region of the user's head. Such a recommendation may be made for based on an image of the user (e.g., image 202a), e.g., as originally received.

In additional embodiments, a user-specific recommendation may comprise a product recommendation for a manufactured product. Additionally, or alternatively, in some embodiments, a user-specific recommendation may be displayed on the display screen of a computing device (e.g., user computing device 111c1) with instructions (e.g., a message) for treating, with the manufactured product, the at least one feature identifiable in the pixel data comprising the at least the portion of a hair region of the user's head. In still further embodiments, computing instructions, executing on processor(s) of either a user computing device (e.g., user computing device 111c1) and/or imaging server(s) may initiate, based on a product recommendation, the manufactured product for shipment to the user.

With regard to manufactured product recommendations, in some embodiments, one or more processors (e.g., imaging server(s) 102 and/or a user computing device, such as user computing device 111c1) may generate a modified image based on the at least one image of the user, e.g., as originally received. In such embodiments, the modified image may depict a rendering of how the user's hair is predicted to appear after treating the at least one feature with the manufactured product. For example, the modified image may be modified by updating, smoothing, or changing colors of the pixels of the image to represent a possible or predicted change after treatment of the at least one feature within the pixel data with the manufactured product. The modified image may then be rendered on the display screen of the user computing device (e.g., user computing device 111c1).

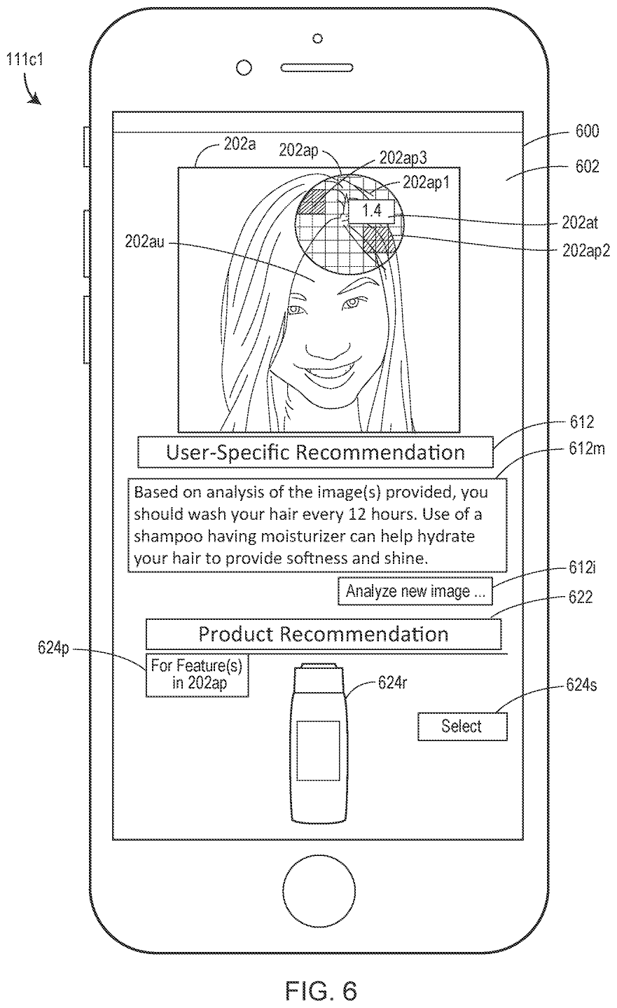

FIG. 6 illustrates an example user interface 602 as rendered on a display screen 600 of a user computing device (e.g., user computing device 111c1) in accordance with various embodiments disclosed herein. For example, as shown in the example of FIG. 6, user interface 602 may be implemented or rendered via an application (app) executing on user computing device 111c1. For example, as shown in the example of FIG. 6, user interface 602 may be implemented or rendered via a native app executing on user computing device 111c1. In the example of FIG. 6, user computing device 111c1 is a user computer device as described for FIG. 1, e.g., where 111c1 is illustrated as an APPLE iPhone that implements the APPLE iOS operating system and that has display screen 600. User computing device 111c1 may execute one or more native applications (apps) on its operating system, including, for example, imaging app as described herein. Such native apps may be implemented or coded (e.g., as computing instructions) in a computing language (e.g., SWIFT) executable by the user computing device operating system (e.g., APPLE iOS) by the processor of user computing device 111c1.

Additionally, or alternatively, user interface 602 may be implemented or rendered via a web interface, such as via a web browser application, e.g., Safari and/or Google Chrome app(s), or other such web browser or the like.

As shown in the example of FIG. 6, user interface 602 comprises a graphical representation (e.g., of image 202a) of the user 202au. Image 202a may comprise the at least one image of the user (or graphical representation thereof) comprising pixel data (e.g., pixel data 202ap) of at least a portion of a hair region of the user's head as described herein. In the example of FIG. 6, graphical representation (e.g., image 202a) of the user is annotated with one or more graphics (e.g., areas of pixel data 202ap) or textual rendering(s) (e.g., text 202at) corresponding to various features identifiable within the pixel data comprising a portion of a hair region of the user's head. For example, the area of pixel data 202ap may be annotated or overlaid on top of the image of the user (e.g., image 202a) to highlight the area or feature(s) identified within the pixel data (e.g., feature data and/or raw pixel data) by the hair based learning model (e.g., hair based learning model 108). In the example of FIG. 6, the area of pixel data 202ap indicates features, as defined in pixel data 202ap, including frizz (e.g., for pixel 202ap1), alignment (e.g., for pixel 202ap2), and shine (e.g., for pixel 202ap3), and other features shown in area of pixel data 202ap, as described herein. In various embodiments, the pixels identified as the specific features, including frizz (e.g., pixel 202ap1), alignment (e.g., pixel 202ap2), and shine (e.g., as pixel 202ap3) may be highlighted or otherwise annotated when rendered on display screen 600.

Textual rendering (e.g., text 202at) shows a user-specific attribute or feature (e.g., 1.4 for pixel 202ap2) which indicates that the user has a hair quality score (of 1.4) for frizz. The 1.4 score indicates that the user has a low frizz hair quality score such that the user would likely benefit from washing her hair to improve hair quality (e.g., frizz quality). It is to be understood that other textual rendering types or values are contemplated herein, where textual rendering types or values may be rendered, for example, such as hair quality scores for alignment, shine, oiliness, or the like. Additionally, or alternatively, color values may be used and/or overlaid on a graphical representation shown on user interface 602 (e.g., image 202a) to indicate a degree or quality of a given hair quality score, e.g., a high score of 2.5 or a low score of 1.0 (e.g., scores as shown for FIG. 5B), or otherwise. The scores may be provided as raw scores, absolute scores, percentage based, scores. Additionally, or alternatively, such scores may be presented with textual or graphical indicators indicating whether or not a score is representative of a positive results (good hair washing frequency), negative results (poor hair washing frequency), or acceptable results (average or acceptable hair washing frequencies).

User interface 602 may also include or render a user-specific electronic recommendation 612. In the embodiment of FIG. 6, user-specific electronic recommendation 612 comprises a message 612m to the user designed to address at least one feature identifiable within the pixel data comprising the portion of a hair region of the user's head. As shown in the example of FIG. 6, message 612m recommends to the user to wash her hair every 12 hours.

Message 612m further recommends use of a shampoo having moisturizer to help hydrate the user's hair to provide softness and shine. The shampoo recommendation can be made based on the low hair quality score for frizz (e.g., 1.4) suggesting that the image of the user depicts a poor frizz score, where the shampoo product is designed to address frizz detected or classified in the pixel data of image 202a or otherwise assumed based on the low hair quality score, or classification, for frizz. The product recommendation can be correlated to the identified feature within the pixel data, and the user computing device 111c1 and/or server(s) 102 can be instructed to output the product recommendation when the feature (e.g., excessive frizz) is identified or classified (e.g., frizz image classification 3000.

User interface 602 may also include or render a section for a product recommendation 622 for a manufactured product 624r (e.g., shampoo as described above). The product recommendation 622 may correspond to the user-specific electronic recommendation 612, as described above. For example, in the example of FIG. 6, the user-specific electronic recommendation 612 may be displayed on display screen 600 of user computing device 111c1 with instructions (e.g., message 612m) for treating, with the manufactured product (manufactured product 624r (e.g., shampoo)) at least one feature (e.g., low hair quality score of 1.4 related to hair frizz at pixel 202ap1) identifiable in the pixel data (e.g., pixel data 202ap) comprising pixel data of at least a portion of a hair region of the user's head.

As shown in FIG. 6, user interface 602 recommends a product (e.g., manufactured product 624r (e.g., shampoo)) based on the user-specific electronic recommendation 612. In the example of FIG. 6, the output or analysis of image(s) (e.g. image 202a) of hair based learning model (e.g., hair based learning model 108), e.g., user-specific electronic recommendation 612 and/or its related values (e.g., 1.4 hair quality score) or related pixel data (e.g., 202ap1, 202ap2, and/or 202ap3), may be used to generate or identify recommendations for corresponding product(s). Such recommendations may include products such as shampoo, conditioner, hair gel, moisturizing treatments, and the like to address the user-specific issue as detected within the pixel data by the hair based learning model (e.g., hair based learning model 108).

In the example of FIG. 6, user interface 602 renders or provides a recommended product (e.g., manufactured product 624r) as determined by hair based learning model (e.g., hair based learning model 108) and its related image analysis of image 202a and its pixel data and various features. In the example of FIG. 6, this is indicated and annotated (624p) on user interface 602.

User interface 602 may further include a selectable UI button 624s to allow the user (e.g., the user of image 202a) to select for purchase or shipment the corresponding product (e.g., manufactured product 624r). In some embodiments, selection of selectable UI button 624s may cause the recommended product(s) to be shipped to the user (e.g., user 202au) and/or may notify a third party that the individual is interested in the product(s). For example, either user computing device 111c1 and/or imaging server(s) 102 may initiate, based on user-specific electronic recommendation 612, the manufactured product 624r (e.g., shampoo) for shipment to the user. In such embodiments, the product may be packaged and shipped to the user.

In various embodiments, a graphical representation (e.g., image 202a), with graphical annotations (e.g., area of pixel data 202ap), textual annotations (e.g., text 202at), user-specific electronic recommendation 612 may be transmitted, via the computer network (e.g., from an imaging server 102 and/or one or more processors) to user computing device 111c1, for rendering on display screen 600. In other embodiments, no transmission to the imaging server of the user's specific image occurs, where the user-specific recommendation (and/or product specific recommendation) may instead be generated locally, by the hair based learning model (e.g., hair based learning model 108) executing and/or implemented on the user's mobile device (e.g., user computing device 111c1) and rendered, by a processor of the mobile device, on display screen 600 of the mobile device (e.g., user computing device 111c1).

In some embodiments, any one or more of graphical representations (e.g., image 202a), with graphical annotations (e.g., area of pixel data 202ap), textual annotations (e.g., text 202at), user-specific electronic recommendation 612, and/or product recommendation 622 may be rendered (e.g., rendered locally on display screen 600) in real-time or near-real time during or after receiving, the image having the hair region of the user's head. In embodiments where the image is analyzed by imaging server(s) 102, the image may be transmitted and analyzed in real-time or near real-time by imaging server(s) 102.

In some embodiments, the user may provide a new image that may be transmitted to imaging server(s) 102 for updating, retraining, or reanalyzing by hair based learning model 108. In other embodiments, a new image that may be locally received on computing device 111c1 and analyzed, by hair based learning model 108, on the computing device 111c1.

In addition, as shown in the example of FIG. 6, the user may select selectable button 612i for reanalyzing (e.g., either locally at computing device 111c1 or remotely at imaging server(s) 102) a new image. Selectable button 612i may cause user interface 602 to prompt the user to attach for analyzing a new image. Imaging server(s) 102 and/or a user computing device such as user computing device 111c1 may receive a new image comprising pixel data of at least a portion of a hair region of the user's head. The new image may be captured by the digital camera. The new image (e.g., similar to image 202a) may comprise pixel data of at least a portion of a hair region of the user's head. The hair based learning model (e.g., hair based learning model 108), executing on the memory of the computing device (e.g., imaging server(s) 102), may analyze the new image captured by the digital camera to determine an image classification of the user's hair region. The computing device (e.g., imaging server(s) 102) may generate, based on a comparison of the image and the second image or the classification or the second classification of the user's hair region, a new user-specific electronic recommendation or comment regarding at least one feature identifiable within the pixel data of the new image. For example the new user-specific electronic recommendation may include a new graphical representation including graphics and/or text (e.g., showing a new hair quality score value, e.g., 2.5, after the user washed here hair). The new user-specific electronic recommendation may include additional recommendations, e.g., that the user has successfully washed her hair to reduce frizz as detected with the pixel data of the new image. A comment may include that the user needs to correct additional features detected within the pixel data, e.g., hair alignment, by applying an additional product, e.g., hair gel.

In various embodiments, the new user-specific recommendation or comment may be transmitted via the computer network, from server(s) 102, to the user computing device of the user for rendering on the display screen 600 of the user computing device (e.g., user computing device 111c1).

In other embodiments, no transmission to the imaging server of the user's new image occurs, where the new user-specific recommendation (and/or product specific recommendation) may instead be generated locally, by the hair based learning model (e.g., hair based learning model 108) executing and/or implemented on the user's mobile device (e.g., user computing device 111c1) and rendered, by a processor of the mobile device, on a display screen of the mobile device (e.g., user computing device 111c1).

### ASPECTS OF THE DISCLOSURE

The following aspects are provided as examples in accordance with the disclosure herein and are not intended to limit the scope of the disclosure.

1. A digital imaging and learning system configured to analyze pixel data of an image of a hair region of a user's head to generate one or more user-specific recommendations, the digital imaging and learning system comprising: one or more processors; an imaging application (app) comprising computing instructions configured to execute on the one or more processors; and a hair based learning model, accessible by the imaging app, and trained with pixel data of a plurality of training images depicting hair regions of heads of respective individuals, the hair based learning model configured to output one or more image classifications corresponding to one or more features of hair of the respective individuals, wherein the computing instructions of the imaging app when executed by the one or more processors, cause the one or more processors to: receive an image of a user, the image comprising a digital image as captured by a digital camera, and the image comprising pixel data of at least a portion of a hair region of the user's head, analyze, by the hair based learning model, the image as captured by the digital camera to determine an image classification of the user's hair region, the image classification selected from the one or more image classifications of the hair based learning model, generate, based on the image classification of the user's hair region, at least one user-specific recommendation designed to address at least one feature identifiable within the pixel data comprising the at least the portion of a hair region of the user's head, and render, on a display screen of a computing device, the at least one user-specific recommendation.

2. The digital imaging and learning system of aspect 1, wherein the one or more image classifications comprise one or more of: (1) a hair frizz image classification; (2) a hair alignment image classification; (3) a hair shine image classification; (4) a hair oiliness classification; (5) a hair volume classification; (6) a hair color classification; or (7) a hair type classification.

3. The digital imaging and learning system of any one of aspects 1 or 2, wherein the computing instructions further cause the one or more processors to: analyze, by the hair based learning model, the image captured by the digital camera to determine a second image classification of the user's hair region as selected from the one or more image classifications of the hair based learning model, wherein the user-specific recommendation is further based on the second image classification of the user's hair region.

4. The digital imaging and learning system of any one of aspects 1-3, wherein the one or more features of the hair of the user comprise one or more of: (1) one or more hairs sticking out; (2) hair fiber shape or relative positioning; (3) one or more continuous hair shine bands; or (4) hair oiliness.

5. The digital imaging and learning system of any one of aspects 1-4, wherein the hair region of the user's head comprises at least one of: a front hair region, a back hair region, a side hair region, a top hair region, a full hair region, a partial hair region, or a custom defined hair region.

6. The digital imaging and learning system of any one of aspects 1-5, wherein the hair region depicts a hair status of the user's hair identifiable with the pixel data, the hair status comprising at least one of: a hair tied-up status, a hair open status, a hair styled status, or a non-styled status.

7. The digital imaging and learning system of any one of aspects 1-6, wherein one or more of the plurality of training images or the least one image of the user each comprise one or more cropped images depicting hair with at least one or more facial features of the user removed.

8. The digital imaging and learning system of aspect 7, wherein the one or more cropped images comprise one or more extracted hair regions of the user without depicting personal identifiable information (PII).

9. The digital imaging and learning system of any one of aspects 1-8, wherein one or more of the plurality of training images or the least one image of the user each comprise multiple angles or perspectives depicting hair regions of each of the respective individuals or the user.

10. The digital imaging and learning system of any one of aspects 1-9, wherein the at least one user-specific recommendation is displayed on the display screen of the computing device with instructions for treating the at least one feature identifiable in the pixel data comprising the at least the portion of a hair region of the user's head.

11. The digital imaging and learning system of any one of aspects 1-10, wherein the at least one user-specific recommendation comprises a recommended wash frequency specific to the user.

12. The digital imaging and learning system of any one of aspects 1-11, wherein the at least one user-specific recommendation comprises a hair quality score as determined based on the pixel data of at least a portion of a hair region of the user's head and one or more image classifications selected from the one or more image classifications of the hair based learning model.

13. The digital imaging and learning system of any one of aspects 1-12, wherein the computing instructions further cause the one or more processors to: record, in one or more memories communicatively coupled to the one or more processors, the image of the user as captured by the digital camera at a first time for tracking changes to user's hair region over time, receive a second image of the user, the second image captured by the digital camera at a second time, and the second image comprising pixel data of at least a portion of a hair region of the user's head, analyze, by the hair based learning model, the second image captured by the digital camera to determine, at the second time, a second image classification of the user's hair region as selected from the one or more image classifications of the hair based learning model, generate, based on a comparison of the image and the second image or the classification or the second classification of the user's hair region, a new user-specific recommendation or comment regarding at least one feature identifiable within the pixel data of the second image comprising the at least the portion of a hair region of the user's head, render, on a display screen of a computing device, the new user-specific recommendation or comment.

14. The digital imaging and learning system of aspect 13, wherein the new user-specific recommendation or comment comprises a textual, visual, or virtual comparison of the at least the portion the a hair region of the user's head between the first time and the second time.

15. The digital imaging and learning system of any one of aspects 1-14, wherein the at least one user-specific recommendation is rendered on the display screen in real-time or near-real time, during, or after receiving, the image having the hair region of the user's head.

16. The digital imaging and learning system of any one of aspects 1-15, wherein the at least one user-specific recommendation comprises a product recommendation for a manufactured product.

17. The digital imaging and learning system of aspect 16, wherein the at least one user-specific recommendation is displayed on the display screen of the computing device with instructions for treating, with the manufactured product, the at least one feature identifiable in the pixel data comprising the at least the portion of a hair region of the user's head.

18. The digital imaging and learning system of aspect 16, wherein the computing instructions further cause the one or more processors to: initiate, based on the product recommendation, the manufactured product for shipment to the user.

19. The digital imaging and learning system of aspect 16, wherein the computing instructions further cause the one or more processors to: generate a modified image based on the image, the modified image depicting how the user's hair is predicted to appear after treating the at least one feature with the manufactured product; and render, on the display screen of the computing device, the modified image.

20. The digital imaging and learning system of any one of aspects 1-19, wherein the hair based learning model is an artificial intelligence (AI) based model trained with at least one AI algorithm.

21. The digital imaging and learning system of any one of aspects 1-21, wherein the hair based learning model is further trained, by the one or more processors with the pixel data of the plurality of training images, to output one or more hair types corresponding to the hair regions of heads of respective individuals, and wherein each of the one or more hair types defines specific hair type attributes, and wherein determination of the image classification of the user's hair region is further based on a hair type or specific hair type attributes of the at least the portion of a hair region of the user's head.

22. The digital imaging and learning system of aspect 21, wherein the one or more hair types correspond to one or more user demographics or ethnicities.

23. The digital imaging and learning system of any one of aspects 1-22, wherein at least one of the one or more processors comprises a mobile processor of a mobile device, and wherein the digital camera comprises a digital camera of the mobile device.

24. The digital imaging and learning system of aspect 23, wherein the mobile device comprises at least one of a mobile phone, a tablet, a handheld device, a personal assistant device, or a retail computing device.

25. The digital imaging and learning system of any one of aspects 1-24, wherein the one or more processors comprises a server processor of a server, wherein the server is communicatively coupled to a mobile device via a computer network, and where the imaging app comprises a server app portion configured to execute on the one or more processors of the server and a mobile app portion configured to execute on one or more processors of the mobile device, the server app portion configured to communicate with the mobile app portion, wherein the server app portion is configured to implement one or more of: (1) receiving the image captured by the digital camera; (2); determining the image classification of the user's hair; (3) generating the user-specific recommendation; or (4) transmitting the one user-specific recommendation to the mobile app portion.

26. A digital imaging and learning method for analyzing pixel data of an image of a hair region of a user's head to generate one or more user-specific recommendations, the digital imaging and learning method comprising: receiving, at an imaging application (app) executing on one or more processors, an image of a user, the image comprising a digital image as captured by a digital camera, and the image comprising pixel data of at least a portion of a hair region of the user's head; analyzing, by a hair based learning model accessible by the imaging app, the image as captured by the digital camera to determine an image classification of the user's hair region, the image classification selected from one or more image classifications of the hair based learning model, wherein the hair based learning model is trained with pixel data of a plurality of training images depicting hair regions of heads of respective individuals, the hair based learning model operable to output the one or more image classifications corresponding to one or more features of hair of the respective individuals; generating, by the imaging app based on the image classification of the user's hair region, at least one user-specific recommendation designed to address at least one feature identifiable within the pixel data comprising the at least the portion of a hair region of the user's head; and rendering, by the imaging app on a display screen of a computing device, the at least one user-specific recommendation.

27. A tangible, non-transitory computer-readable medium storing instructions for analyzing pixel data of an image of a hair region of a user's head to generate one or more user-specific recommendations, that when executed by one or more processors cause the one or more processors to: receive, at an imaging application (app), an image of a user, the image comprising a digital image as captured by a digital camera, and the image comprising pixel data of at least a portion of a hair region of the user's head; analyze, by a hair based learning model accessible by the imaging app, the image as captured by the digital camera to determine an image classification of the user's hair region, the image classification selected from one or more image classifications of the hair based learning model, wherein the hair based learning model is trained with pixel data of a plurality of training images depicting hair regions of heads of respective individuals, the hair based learning model operable to output the one or more image classifications corresponding to one or more features of hair of the respective individuals; generate, by the imaging app based on the image classification of the user's hair region, at least one user-specific recommendation designed to address at least one feature identifiable within the pixel data comprising the at least the portion of a hair region of the user's head; and render, by the imaging app on a display screen of a computing device, the at least one user-specific recommendation.

### ADDITIONAL CONSIDERATIONS

Although the disclosure herein sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location, while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other embodiments, the one or more processors or processor-implemented modules may be distributed across a number of geographic locations.

This detailed description is to be construed as exemplary only and does not describe every possible embodiment, as describing every possible embodiment would be impractical, if not impossible. A person of ordinary skill in the art may implement numerous alternate embodiments, using either current technology or technology developed after the filing date of this application.

Those of ordinary skill in the art will recognize that a wide variety of modifications, alterations, and combinations can be made with respect to the above described embodiments without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A digital imaging and learning system configured to analyze pixel data of an image of a hair region of a user's head to generate one or more user-specific recommendations, the digital imaging and learning system comprising:
one or more processors;
an imaging application (app) comprising computing instructions configured to execute on the one or more processors; and
a hair based learning model, accessible by the imaging app, and trained with pixel data of a plurality of training images depicting hair regions of heads of respective individuals, the hair based learning model configured to output one or more image classifications corresponding to one or more features of hair of the respective individuals,
wherein the computing instructions of the imaging app when executed by the one or more processors, cause the one or more processors to:
receive an image of a user, the image comprising a digital image as captured by a digital camera, and the image comprising pixel data of at least a portion of a hair region of the user's head,
analyze, by the hair based learning model, the image as captured by the digital camera to determine an image classification of the user's hair region, the image classification selected from the one or more image classifications of the hair based learning model,
generate, based on the image classification of the user's hair region, at least one user-specific recommendation designed to address at least one feature identifiable within the pixel data comprising the at least the portion of a hair region of the user's head, and
render, on a display screen of a computing device, the at least one user-specific recommendation.

2. The digital imaging and learning system of claim 1, wherein the one or more image classifications comprise one or more of: (1) a hair frizz image classification; (2) a hair alignment image classification; (3) a hair shine image classification; (4) a hair oiliness classification; (5) a hair volume classification; (6) a hair color classification; or (7) a hair type classification.

3. The digital imaging and learning system of claim 1, wherein the computing instructions further cause the one or more processors to:
analyze, by the hair based learning model, the image captured by the digital camera to determine a second image classification of the user's hair region as selected from the one or more image classifications of the hair based learning model,
wherein the user-specific recommendation is further based on the second image classification of the user's hair region.

4. The digital imaging and learning system of claim 1, wherein the one or more features of the hair of the user comprise one or more of: (1) one or more hairs sticking out; (2) hair fiber shape or relative positioning; (3) one or more continuous hair shine bands; or (4) hair oiliness.

5. The digital imaging and learning system of claim 1, wherein the hair region of the user's head comprises at least one of: a front hair region, a back hair region, a side hair region, a top hair region, a full hair region, a partial hair region, or a custom defined hair region.

6. The digital imaging and learning system of claim 1, wherein the hair region depicts a hair status of the user's hair identifiable with the pixel data, the hair status comprising at least one of: a hair tied-up status, a hair open status, a hair styled status, or a non-styled status.

7. The digital imaging and learning system of claim 1, wherein one or more of the plurality of training images or the least one image of the user each comprise one or more cropped images depicting hair with at least one or more facial features of the user removed.

8. The digital imaging and learning system of claim 7, wherein the one or more cropped images comprise one or more extracted hair regions of the user without depicting personal identifiable information (PII).

9. The digital imaging and learning system of claim 1, wherein one or more of the plurality of training images or the least one image of the user each comprise multiple angles or perspectives depicting hair regions of each of the respective individuals or the user.

10. The digital imaging and learning system of claim 1, wherein the at least one user-specific recommendation is displayed on the display screen of the computing device with instructions for treating the at least one feature identifiable in the pixel data comprising the at least the portion of a hair region of the user's head.

11. The digital imaging and learning system of claim 1, wherein the at least one user-specific recommendation comprises a recommended wash frequency specific to the user.

12. The digital imaging and learning system of claim 1, wherein the at least one user-specific recommendation comprises a hair quality score as determined based on the pixel data of at least a portion of a hair region of the user's head and one or more image classifications selected from the one or more image classifications of the hair based learning model.

13. The digital imaging and learning system of claim 1, wherein the computing instructions further cause the one or more processors to:
record, in one or more memories communicatively coupled to the one or more processors, the image of the user as captured by the digital camera at a first time for tracking changes to user's hair region over time,
receive a second image of the user, the second image captured by the digital camera at a second time, and the second image comprising pixel data of at least a portion of a hair region of the user's head,
analyze, by the hair based learning model, the second image captured by the digital camera to determine, at the second time, a second image classification of the user's hair region as selected from the one or more image classifications of the hair based learning model,
generate, based on a comparison of the image and the second image or the classification or the second classification of the user's hair region, a new user-specific recommendation or comment regarding at least one feature identifiable within the pixel data of the second image comprising the at least the portion of a hair region of the user's head,
render, on a display screen of a computing device, the new user-specific recommendation or comment.

14. The digital imaging and learning system of claim 13, wherein the new user-specific recommendation or comment comprises a textual, visual, or virtual comparison of the at least the portion the a hair region of the user's head between the first time and the second time.

15. The digital imaging and learning system of claim 1, wherein the at least one user-specific recommendation is rendered on the display screen in real-time or near-real time, during, or after receiving, the image having the hair region of the user's head.

16. The digital imaging and learning system of claim 1, wherein the at least one user-specific recommendation comprises a product recommendation for a manufactured product.

17. The digital imaging and learning system of claim 16, wherein the at least one user-specific recommendation is displayed on the display screen of the computing device with instructions for treating, with the manufactured product, the at least one feature identifiable in the pixel data comprising the at least the portion of a hair region of the user's head.

18. The digital imaging and learning system of claim 16, wherein the computing instructions further cause the one or more processors to:
initiate, based on the product recommendation, the manufactured product for shipment to the user.

19. The digital imaging and learning system of claim 16, wherein the computing instructions further cause the one or more processors to:
generate a modified image based on the image, the modified image depicting how the user's hair is predicted to appear after treating the at least one feature with the manufactured product; and
render, on the display screen of the computing device, the modified image.

20. The digital imaging and learning system of claim 1, wherein the hair based learning model is an artificial intelligence (AI) based model trained with at least one AI algorithm.

21. The digital imaging and learning system of claim 1,
wherein the hair based learning model is further trained, by the one or more processors with the pixel data of the plurality of training images, to output one or more hair types corresponding to the hair regions of heads of respective individuals, and
wherein each of the one or more hair types defines specific hair type attributes, and
wherein determination of the image classification of the user's hair region is further based on a hair type or specific hair type attributes of the at least the portion of a hair region of the user's head.

22. The digital imaging and learning system of claim 21, wherein the one or more hair types correspond to one or more user demographics or ethnicities.

23. The digital imaging and learning system of claim 1, wherein at least one of the one or more processors comprises a mobile processor of a mobile device, and wherein the digital camera comprises a digital camera of the mobile device.

24. The digital imaging and learning system of claim 23, wherein the mobile device comprises at least one of a mobile phone, a tablet, a handheld device, a personal assistant device, or a retail computing device.

25. The digital imaging and learning system of claim 1, wherein the one or more processors comprises a server processor of a server, wherein the server is communicatively coupled to a mobile device via a computer network, and where the imaging app comprises a server app portion configured to execute on the one or more processors of the server and a mobile app portion configured to execute on one or more processors of the mobile device, the server app portion configured to communicate with the mobile app portion, wherein the server app portion is configured to implement one or more of: (1) receiving the image captured by the digital camera; (2); determining the image classification of the user's hair; (3) generating the user-specific recommendation; or (4) transmitting the one user-specific recommendation to the mobile app portion.

26. A digital imaging and learning method for analyzing pixel data of an image of a hair region of a user's head to generate one or more user-specific recommendations, the digital imaging and learning method comprising:
receiving, at an imaging application (app) executing on one or more processors, an image of a user, the image comprising a digital image as captured by a digital camera, and the image comprising pixel data of at least a portion of a hair region of the user's head;
analyzing, by a hair based learning model accessible by the imaging app, the image as captured by the digital camera to determine an image classification of the user's hair region, the image classification selected from one or more image classifications of the hair based learning model, wherein the hair based learning model is trained with pixel data of a plurality of training images depicting hair regions of heads of respective individuals, the hair based learning model operable to output the one or more image classifications corresponding to one or more features of hair of the respective individuals;
generating, by the imaging app based on the image classification of the user's hair region, at least one user-specific recommendation designed to address at least one feature identifiable within the pixel data comprising the at least the portion of a hair region of the user's head; and
rendering, by the imaging app on a display screen of a computing device, the at least one user-specific recommendation.

27. A tangible, non-transitory computer-readable medium storing instructions for analyzing pixel data of an image of a hair region of a user's head to generate one or more user-specific recommendations, that when executed by one or more processors cause the one or more processors to:
receive, at an imaging application (app), an image of a user, the image comprising a digital image as captured by a digital camera, and the image comprising pixel data of at least a portion of a hair region of the user's head;
analyze, by a hair based learning model accessible by the imaging app, the image as captured by the digital camera to determine an image classification of the user's hair region, the image classification selected from one or more image classifications of the hair based learning model, wherein the hair based learning model is trained with pixel data of a plurality of training images depicting hair regions of heads of respective individuals, the hair based learning model operable to output the one or more image classifications corresponding to one or more features of hair of the respective individuals;
generate, by the imaging app based on the image classification of the user's hair region, at least one user-specific recommendation designed to address at least one feature identifiable within the pixel data comprising the at least the portion of a hair region of the user's head; and
render, by the imaging app on a display screen of a computing device, the at least one user-specific recommendation.
